(19) United States
(12) Patent Application Publication
(10) Pub. No.: US 2019/0044853 A1
(43) Pub. Date: Feb. 7, 2019

(54) SWITCH-ASSISTED DATA STORAGE NETWORK TRAFFIC MANAGEMENT IN A DATA STORAGE CENTER

(71) Applicant: INTEL CORPORATION, Santa Clara, CA (US)

(72) Inventors: Arun RAGHUNATH, Portland, OR (US); Anjaneya Reddy CHAGAM REDDY, Chandler, AZ (US); Yi ZOU, Portland, OR (US)

(21) Appl. No.: 15/870,709

(22) Filed: Jan. 12, 2018

(51) Int. Cl. H04L 12/773; G06F 3/06; H04L 29/08; G06F 17/30

(52) U.S. Cl. CPC H04L 45/60; G06F 3/0607; G06F 17/30194; H04L 67/1097; G06F 3/0611

(57) ABSTRACT

In one embodiment, switch-assisted data storage network traffic management in a data storage center consolidates data placement requests and data placement acknowledgements to reduce network traffic. Other aspects are described herein.

### TECHNICAL FIELD

Certain embodiments of the present invention relate generally to switch-assisted data storage network traffic management in a data storage center.

### BACKGROUND

Data storage centers typically employ distributed storage systems to store large quantities of data. To enhance the reliability of such storage, various data redundancy techniques such as full data replication or erasure coded (EC) data are employed. Erasure coding based redundancy can provide improved storage capacity efficiency in large scale systems and thus is relied upon in many commercial distributed cloud storage systems.

Erasure coding can be described generally by the term EC(k,m), where a client's original input data for storage is split into k data chunks. In addition, m parity chunks are computed based upon a distribution matrix. Reliability from data redundancy may be achieved by separately placing each of the total k+m encoded chunks into different k+m storage nodes. As a result, should any m (or less than m) encoded chunks be lost due to failure of storage nodes or other causes such as erasure, the client's original data may be reconstructed from the surviving k encoded chunks of client storage data or parity data.

In a typical distributed data storage system, a client node generates separate data placement requests for each chunk of data, in which each placement request is a request to place a particular chunk of data in a particular storage node of the system. Thus, where redundancy is provided by erasure coding, the client node will typically generate k+m separate data placement requests, one data placement request for each of the k+m chunks of client data. The k+m data placement requests are transmitted through various switches of the distributed data storage system to the storage nodes for storage. Each data placement requests typically includes a destination address which is the address of a particular storage node which has been assigned to store the data chunk being carried by the data placement request as a payload of the data placement request. The switches through which the data placement requests pass, note the intended destination address of the data placement request and route the data placement request to the assigned storage node for storage of the data chunk carried as a payload of the request. For example, the destination address may be in the form of a TCP/IP (Transmission Control Protocol/Internet Protocol) address such that a TCP/IP connection is formed for each TCP/IP destination.

### BRIEF DESCRIPTION OF THE DRAWINGS

Embodiments of the present disclosure are illustrated by way of example, and not by way of limitation, in the figures of the accompanying drawings in which like reference numerals refer to similar elements.

FIG. 1 depicts a high-level block diagram illustrating an example of prior art individual data placement requests being routed through a prior art storage network for a data storage system.

FIG. 2 depicts a prior art erasure encoding scheme for encoding data in chunks for storage in the data storage system.

FIG. 3 depicts individual data placement requests of FIG. 1, each request for placing an individual encoded chunk of data of FIG. 2 in an assigned storage node of the data storage system.

FIG. 4 depicts an example of prior art individual data placement acknowledgements being routed through a prior art storage network for a data storage system.

FIG. 5 depicts a high-level block diagram illustrating an example of switch-assisted data storage network traffic management in a data storage center in accordance with an embodiment of the present disclosure.

FIG. 6 depicts an example of a consolidated data placement request of FIG. 5, for placing multiple encoded chunks of data in storage nodes of the data storage system.

FIG. 7 depicts an example of operations of a client node employing switch-assisted data storage network traffic management in a data storage center in accordance with an embodiment of the present disclosure.

FIGS. 8A-8E illustrate examples of logic of various network nodes and switches employing switch-assisted data storage network traffic management in a data storage center in accordance with an embodiment of the present disclosure.

FIG. 9 depicts another example of switch-assisted data storage network traffic management in a data storage center in accordance with an embodiment of the present disclosure.

FIG. 10 depicts an example of operations of a network switch employing switch-assisted data storage network traffic management in a data storage center in accordance with an embodiment of the present disclosure.

FIG. 11 depicts additional examples of consolidated data placement requests of FIG. 5, for placing multiple encoded chunks of data in storage nodes of the data storage system.

FIG. 12 depicts another example of operations of a network switch employing switch-assisted data storage network traffic management in a data storage center in accordance with an embodiment of the present disclosure.

FIG. 13 depicts an example of data chunk placement requests of FIG. 5, for placing encoded chunks of data in storage nodes of the data storage system.

FIG. 14 depicts an example of operations of a network storage node in a data storage center in accordance with an embodiment of the present disclosure.

FIG. 15 depicts an example of data chunk placement acknowledgements of FIG. 9, for acknowledging placement of encoded chunks of data in storage nodes of the data storage system.

FIG. 16 depicts an example of consolidated multi-chunk placement acknowledgements of FIG. 9, for acknowledging placement of encoded chunks of data in storage nodes of the data storage system.

FIG. 17 depicts another example of consolidated multi-chunk placement acknowledgements of FIG. 9, for acknowledging placement of encoded chunks of data in storage nodes of the data storage system.

FIG. 18 depicts an example of logic of a network storage node or network switch in a storage system employing aspects of switch-assisted data storage network traffic management in accordance with an embodiment of the present disclosure.

### DESCRIPTION OF EMBODIMENTS

In the description that follows, like components have been given the same reference numerals, regardless of whether they are shown in different embodiments. To illustrate an embodiment(s) of the present disclosure in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

As noted above, where redundancy is provided by erasure coding (EC), a prior client node will typically generate k+m separate data placement requests, one data placement request for each of the k+m chunks of client and parity data. Thus, for erasure coding, it is appreciated herein that there is generally a considerable amount of additional storage network traffic generated, and as a result, substantial network bandwidth is frequently required to place the redundant chunks of EC encoded data on to the storage nodes of the storage system. It is further appreciated that due to the nature of splitting the original client data into a number of encoded chunks including parity data, the latency of the various data placement requests may also be exacerbated since all data placement requests for the encoded chunks of data are typically concurrently handled in the same manner as they are routed from the client node to the storage nodes and the storage media of the storage nodes.

Moreover, the k+m separate data placement requests typically result in k+m separate acknowledgements, one acknowledgement for each of the data placement request as the data of a request is successfully stored in a storage node. Thus, the separate acknowledgements can also contribute to additional storage network traffic and as a result, can also increase storage network bandwidth requirements.

As explained in greater detail below, switch-assisted data storage network traffic management in accordance with one aspect of the present, may substantially reduce added storage network traffic generated as a result of EC or other redundancy techniques and as a result, substantially reduce both costs of network bandwidth and data placement latency. More specifically, in distributed data storage systems employing multiple racks of data storage nodes, both intra-rack and inter-rack network traffic carrying data to be stored may be reduced notwithstanding that EC encoded data chunks or other redundancy methods are employed for reliability purposes. Moreover, both intra-rack and inter-rack network traffic acknowledging placement of EC encoded data chunks in assigned storage nodes, may be reduced as well. However, it is appreciated that features and advantages of employing switch-assisted data storage network traffic management in accordance with the present description may vary, depending upon the particular application.

In one aspect of the present description, Software Defined Storage (SDS) level information is utilized to improve optimization of data flow within the storage network. In one embodiment, the SDS level information is a function of the hierarchical levels of hierarchical switches interconnecting storage nodes and racks of storage nodes in a distributed storage system. In addition, the SDS level information is employed by the various levels of hierarchical switches to improve optimization of data flow within the storage network.

For example, in one embodiment, a storage network of a distributed data storage system employs top of rack (ToR) switches at a first hierarchical level and end of row (EoR) switches at a second, higher hierarchical level than that of the ToR switches. SDS level information is employed by the various levels of hierarchical EoR and ToR switches to improve optimization of data flow within the storage network.

In another aspect, switch-assisted data storage network traffic management in accordance with one aspect of the present description can facilitate scaling of a distributed data storage system, in which the number of storage nodes, racks of storage nodes and hierarchical levels of switches increases in such scaling. As a result, reductions in both storage network bandwidth and latency achieved by switch-assisted data storage network traffic management in accordance with one aspect of the present description may be even more pronounced as the number of racks of servers or the number of levels of hierarchy deployed for the distributed storage systems increases.

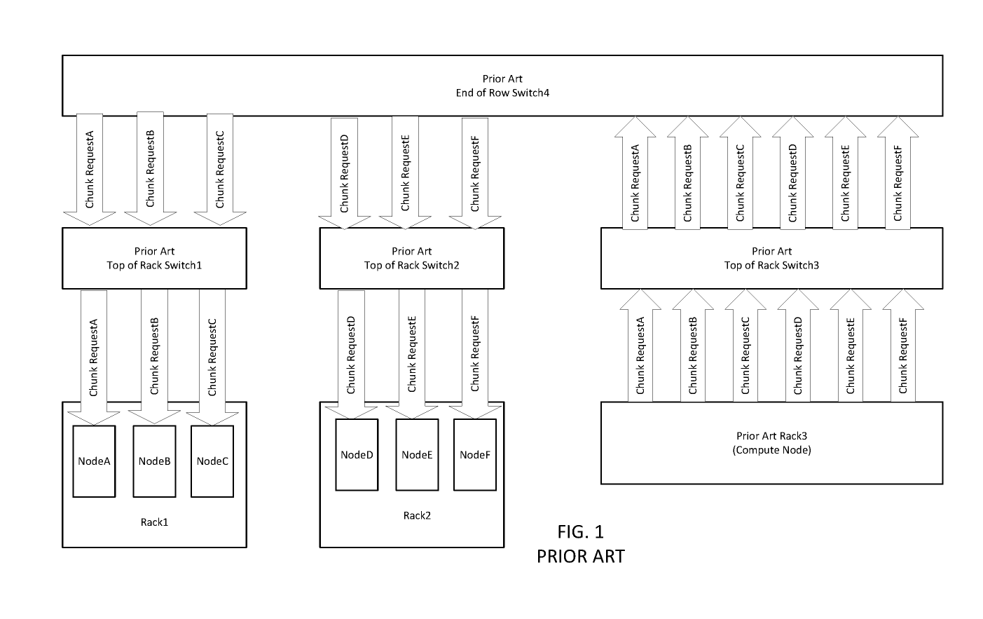

FIG. 1 shows an example of a prior distributed data storage system having two representative data storage racks, Rack1 (containing three representative storage nodes, NodeA-NodeC) and Rack2 (containing three representative storage nodes, NodeD-NodeF), for storing client data. A third rack, Rack3, houses a compute or client node which receives original client data uploaded to the compute node of Rack3.

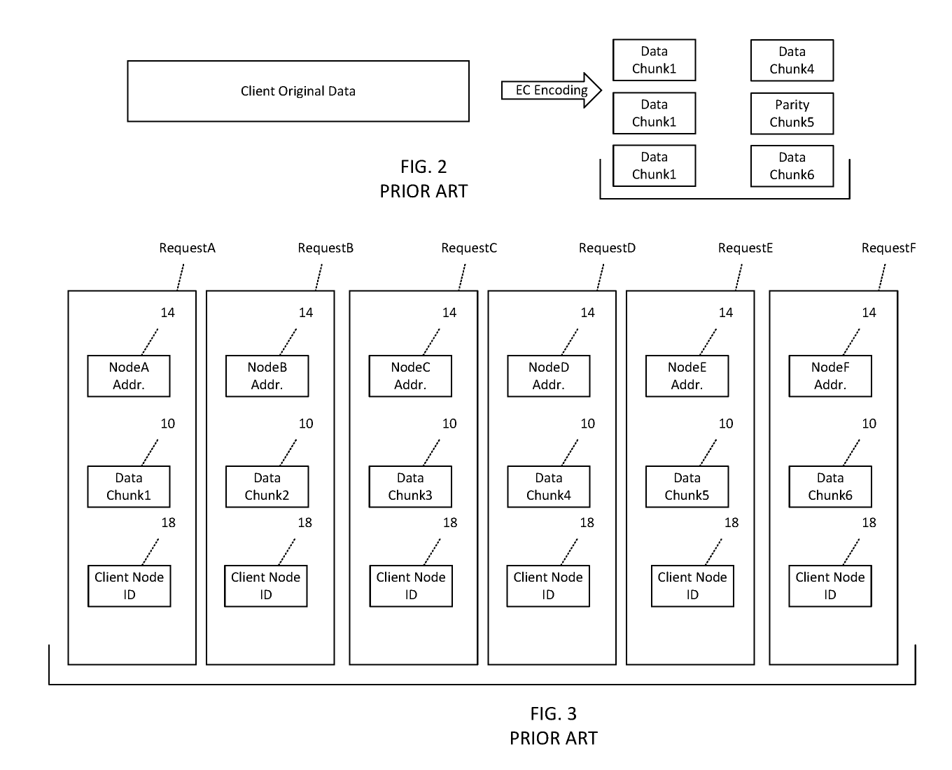

In the example of FIG. 1, when a client or other user uploads any data into the compute node for storage in the data storage system, the compute node uses a known erasure coding algorithm EC(k, m) to encode the original data into k data chunks and m parity chunks, where k+m=r. The total r chunks of encoded data are to be placed on storage media in different failure domains, that is, in different storage nodes within the same rack or storage nodes in different racks according to administrative rules of the storage system. For example, FIG. 2 illustrates an EC scheme with k=4 and m=2, in which original client data is EC encoded into six chunks, Chunk1-Chunk6, that is four data chunks, Chunk1, Chunk2, Chunk4, Chunk5, of equal size, and two parity chunks, Chunk3, Chunk6, each containing parity data.

As previously mentioned, in a typical prior distributed data storage system, a client node such as the compute node of Rack3 (FIG. 1) generates a separate data placement request for each chunk of data to be placed in a storage node. Thus, where redundancy is provided by erasure coding, the client node will typically generate k+m separate data placement requests, one data placement request for each of the k+m chunks of client data. Accordingly, in the example of FIGS. 1, 2, the compute node of Rack3 generates six data placement requests, RequestA-RequestF, one for each chunk, Chunk1-Chunk6, respectively, into which the original client data was EC encoded.

As shown in FIG. 3, each data placement request, RequestA-RequestF, includes a data structure including a payload field 10 containing the encoded chunk to be placed by the request, and a destination address field 14 containing the address of the storage node which has been assigned to store the encoded chunk contained within the payload field 10. The destination address may be in the form of a TCP/IP network address, for example. Thus, each encoded chunk may be routed to an assigned storage node and acknowledged through an individual, end to end TCP/IP connection between each storage node and the client node.

For example, the payload field 10 of the data placement RequestA, for example, contains the encoded chunk Chunk1, and the destination address field 14 of the data placement RequestA has the address of the assigned destination storage NodeA. The payload field 10 of the other data placement requests, RequestB-RequestF, each contain an encoded chunk, Chunk2-Chunk6, respectively and the destination address field 14 of each of the other data placement requests, RequestB-RequestF, has the address of the assigned destination storage node, NodeB-NodeF as shown in FIG. 3. Each data placement request, RequestA-RequestF, may further include a field 18 which identifies the client node making the data placement request.

The k+m data placement requests (RequestA-RequestF in FIGS. 1, 3) are transmitted through various switches of the distributed data storage system to the assigned storage nodes for storage. As noted above, each data placement request typically provides a destination address (field 14 (FIG. 3), for example) of a particular storage node which has been assigned to store the encoded chunk being carried by the data placement request as a payload of the data placement request. The switches through which the data placement requests pass, note the intended address of the data placement request and route the data placement request to the assigned storage node for storage of the encoded chunk of the request.

Thus, in the example of FIG. 1, a top of rack (ToR) switch3 receives the six data placement requests, RequestA-RequestF (FIGS. 1, 3), carrying the six data chunks, Chunk1-Chunk6 (FIG. 3), respectively as payloads 10, and transfers the six data placement requests, RequestA-RequestF, to an end of row (EoR) switch4 (FIG. 1). Three of the data placement requests, RequestA-RequestC, carrying the three data chunks, Chunk1-Chunk3 (FIG. 3), respectively as payloads 10, are routed by the EoR switch4 (FIG. 1) to a top of rack (ToR) switch1 which in turn routes the data placement requests, RequestA-RequestC, to assigned storage nodes such as NodeA-NodeC, respectively, of Rack1 to store the three data chunks, Chunk1-Chunk3, respectively. In a similar manner, the three remaining data placement requests, RequestD-RequestF, carrying the three data and parity encoded chunks, Chunk4-Chunk6 (FIG. 3), respectively as payloads 10, are routed by the EoR switch4 (FIG. 1) to a another top of rack (ToR) switch2 which in turn routes each of the data placement requests, RequestD-RequestF, to an assigned storage node of the storage nodes such as NodeD-NodeF, respectively, of Rack2 to store a data or parity encoded chunk of the three data and parity encoded chunks, Chunk4-Chunk6, respectively.

It is noted that a prior placement of encoded data and parity chunks in the manner depicted in FIG. 1 can provide parallel data and parity chunk placement operations in which such parallel placement operations can improve response time for data placement operations. However, it is further appreciated herein that per chunk communication through the network, that is, routing separate chunk requests for each chunk of the EC encoded chunks through the storage network typically involves multiple hops from the client node and through the various switches to the storage nodes, for each such chunk placement request. As a result, variations in the latency of each such chunk placement request may be introduced for these individual chunks which originated from the same original client data upload.

Moreover, it is further noted that, in a typical prior distributed data storage system, placement of an encoded chunk in each storage node generates a separate acknowledgement which is routed through the storage network of the distributed data storage system. Thus, where the client node generates k+m separate data placement requests, one data placement request for each of the k+m encoded chunks of client data, the storage nodes typically generate k+m acknowledgements in return upon successfully placement of the k+m encoded chunks. Each of the k+m separate data placement requests may identify the source of the data placement request for purposes of addressing acknowledgments to the requesting node.

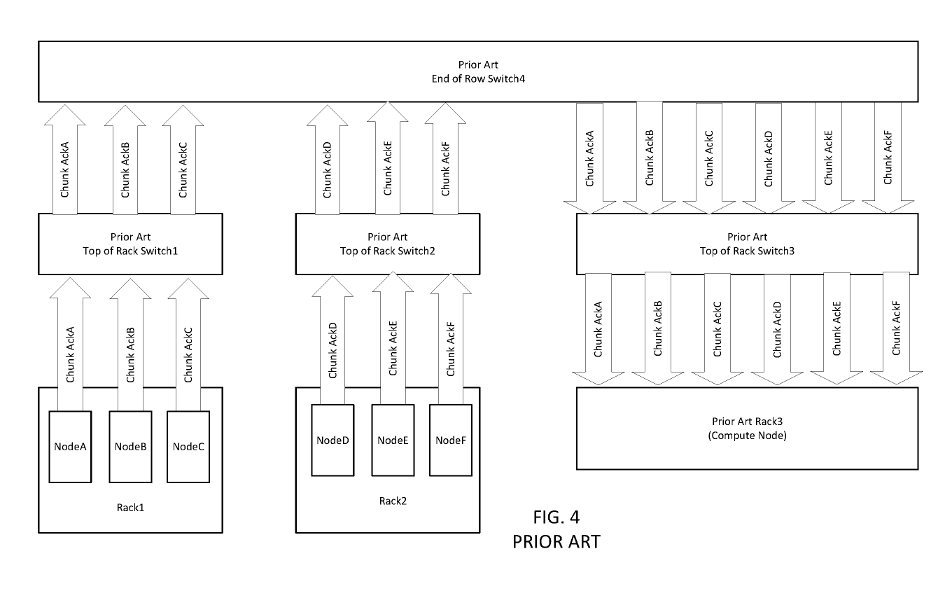

Accordingly, in the example of FIG. 4 the six storage nodes, NodeA-NodeF, generate six data placement acknowledgements, AckA-AckF, one for each encoded chunk, Chunk1-Chunk6, respectively, which were placed into the storage nodes NodeA-NodeF, respectively. Each acknowledgement of the acknowledgements AckA-AckF, may identify the encoded chunk which was successfully stored and identify the storage node in which the identified encoded chunk was stored.

The k+m data placement acknowledgements (AckA-AckF in FIG. 4) are transmitted through various switches of the distributed data storage system back to the client node of Rack3 which generated the six chunk requests, RequestA-RequestF (FIG. 1). In one example, each data placement acknowledgement may provide a destination address of a particular client node which generated the original data placement request being acknowledged. The switches through which the data placement acknowledgements pass, may note an intended destination address of the data placement acknowledgement and route the data placement acknowledgement to the assigned compute node to acknowledge successful storage of the data chunk of the placement request being acknowledged.

Thus, in the example of FIG. 4, three of the data placement acknowledgements, AckA-AckC, acknowledging placement of the three encoded chunks, Chunk1-Chunk3, respectively in the storage nodes NodeA-NodeC, respectively, of rack1, are routed by the top of rack (ToR) switch1 to the end of row (EoR) switch4, which in turn routes the separate data placement acknowledgements, AckA-AckC, to the top of rack switch3 which forwards the separate data placement acknowledgements, AckA-AckC, back to the client or compute node of Rack3 which generated the chunk placement requests, RequestA-RequestC, respectively, acknowledging to the client node the successful placement of the three encoded chunks, Chunk1-Chunk3, respectively, in assigned storage nodes, NodeA-NodeC, respectively, of Rack1. In a similar manner, the three remaining data placement acknowledgements, AckD-AckF, acknowledging placement of the three encoded chunks, Chunk4-Chunk6, respectively in the storage nodes NodeD-NodeF, respectively, are routed by the ToR switch2 to the end of row (EoR) switch4, which in turn routes the separate data placement acknowledgements, AckD-AckF, to the top of rack switch3 which forwards the separate data placement acknowledgements, AckD-AckF, back to the client node of Rack3 which generated the original data placement requests, RequestD-RequestF, respectively, acknowledging to the client node the successful placement of the three encoded chunks, Chunk4-Chunk6, respectively, in assigned storage nodes, NodeD-NodeF, respectively, of Rack2.

It is noted that prior concurrent acknowledgements of placement of encoded data and parity chunks in the manner depicted in FIG. 4 can provide parallel data placement acknowledgment operations in which such parallel acknowledgement operations can improve response time for data placement acknowledgement operations. However, it is further appreciated herein that per chunk communication through the storage network for the separate acknowledgements, that is, routing separate chunk acknowledgements for each EC encoded chunk through the storage network in the manner depicted in FIG. 4 also typically involves multiple hops from the storage nodes, through the various switches and back to the client node, for each such chunk placement acknowledgement. As a result, variations in the latency of each such chunk placement acknowledgement may be introduced for these individual chunks which originated from the same original client data upload.

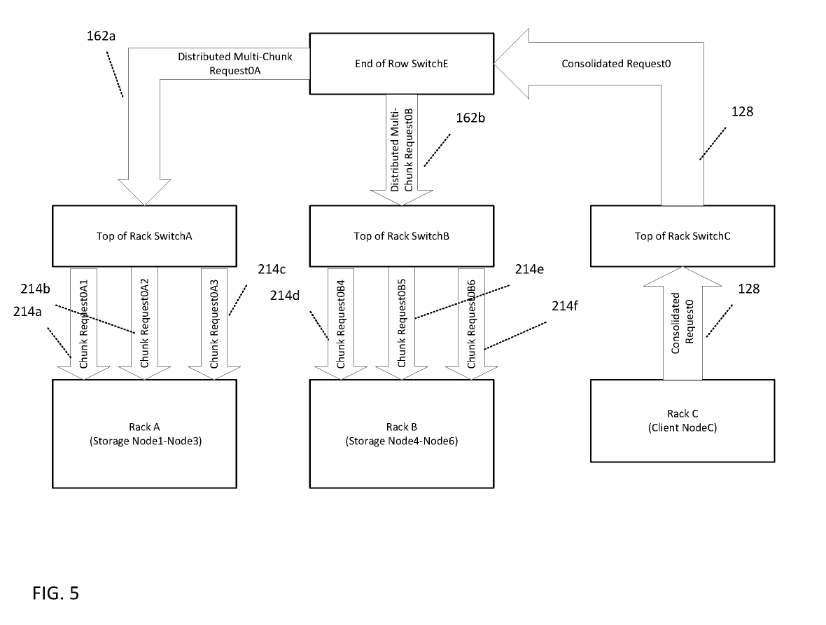

FIG. 5 depicts one embodiment of a data storage center employing switch-assisted data storage network traffic management in accordance with the present description. Such switch-assisted data storage network traffic management can reduce both the inter-rack and intra-rack network traffic. For example, instead of generating k+m separate data placement requests in the manner described above in connection with the prior data center of FIG. 1, EC encoded chunks may be consolidated by a client node such as client NodeC (FIG. 5), for example, into as few as a single consolidated data placement request such as Request0, for example, having a payload of the client data to be placed.

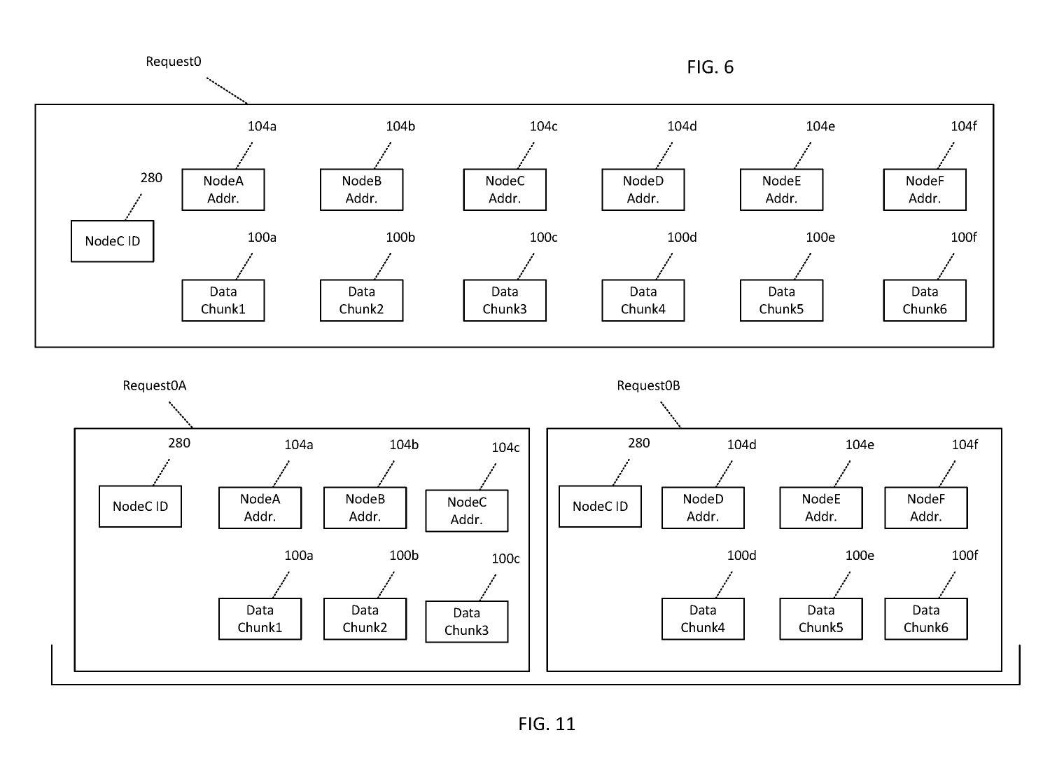

As shown in FIG. 6, consolidated data placement Request0 includes a data structure including a plurality of payload fields such as the payload fields 100a-100f, each containing an encoded chunk to be placed in response to the Request0. Thus, in the embodiment of FIG. 6, the payload fields 100a-100f contain the encoded chunks Chunk1-Chunk6, respectively. In this example, an EC scheme with k=4 and m=2, is utilized in which original client data is EC encoded into six chunks, Chunk1-Chunk6, that is four data chunks, Chunk1, Chunk2, Chunk4, Chunk5, of equal size, and two parity chunks, Chunk3, Chunk6, each containing parity data. In the illustrated embodiment, the client NodeC is configured to encode received client data into chunks of storage data including parity data. However, it is appreciated that such encoding may be performed by other nodes of the storage system. For example, one or more of the logic of the top of rack SwitchC, the end of row SwitchE and the top of rack switches, SwitchA and SwitchB may be configured to erasure encode received data into encoded chunks.

The data structure of the consolidated data placement Request0 further includes in association with the payload fields 100a-100f, a plurality of destination address fields such as the destination address fields 104a-104f to identify the destination address for the associated encoded chunks, Chunk1-Chunk6, respectively. Thus, each destination address field, 104a-104f, contains the address of a storage node which has been assigned to store the encoded chunk contained within the associated the payload field 100a-100f, respectively. For example, the payload field 100a of the consolidated data placement Request0 contains the encoded chunk, Chunk1, and the associated destination address field 104a of the consolidated data placement Request0 contains the address of the assigned destination storage node which is NodeA (FIG. 5) in this example. The payload fields 100b-100f of the consolidated data placement Request0, each contain an encoded chunk, Chunk2-Chunk6, respectively and the associated destination address fields 104b-104f, respectively, of the consolidated data placement Request0 contain the addresses of the assigned destination storage nodes, Node2-Node6, respectively, as shown in FIG. 5.

The destination addresses of the destination address fields 104a-104f may be in the form of TCP/IP network addresses, for example. However, unlike the prior system depicted in FIG. 1, each encoded chunk may be placed in an assigned storage node and acknowledged through consolidated TCP/IP connections instead of individual end to end TCP/IP connections, to reduce storage network traffic and associated bandwidth requirements.

FIG. 7 depicts one example of operations of the client NodeC of FIG. 5. In one embodiment, the client NodeC of RackC of FIG. 4 includes consolidated placement request logic 110 (FIG. 8A) which is configured to receive (block 114, FIG. 7) original client storage data which may be uploaded to the client NodeC by a customer, for example, of the data storage system. The consolidated placement request logic 110 (FIG. 8A) is further configured to encode (block 120, FIG. 7) the received original client data into encoded chunks in a manner similar to that described above in connection with FIG. 5. Thus in one example, the received original client data may be EC encoded in an EC scheme with k=4 and m=2, in which original client data is EC encoded into six chunks, Chunk1-Chunk6, that is four data chunks, Chunk1, Chunk2, Chunk4 and Chunk5, of equal size, and two parity chunks, Chunk3 and Chunk6, containing parity data.

The consolidated placement request logic 110 (FIG. 8A) is further configured to generate (block 124, FIG. 7) and transmit to a higher level hierarchical switch such as the end of row SwitchE of FIG. 5, a consolidated multi-chunk placement request such as the consolidated multi-chunk placement Request0 of FIG. 6. In the illustrated embodiment of FIG. 5, the consolidated placement Request0 is transmitted to the end of row SwitchE via the top of rack SwitchC for rackC which contains the client NodeC.

As described above, the consolidated placement Request0 has a payload (payload fields 100a-100f) containing erasure encoded chunks (Chunk1-Chunk6, respectively) for storage in sets of storage nodes (storage NodeA-NodeF, respectively), as identified by associated destination address fields (104a-104f, respectively). Thus, instead of six individual data placement requests for six separate encoded chunks transmitted in six individual TCP/IP connections as described in connection with the prior system of FIG. 1, the consolidated placement request logic 110 (FIG. 8A) generates and transmits as few as a single consolidated placement Request0 for six encoded chunks of data, in a single TCP/IP connection 128 (FIG. 5) between the client NodeC and the end of row hierarchical SwitchE, via the top of rack SwitchC of FIG. 5. Although described in connection with encoding client data in an EC scheme with k=4 and m=2, in which original client data is EC encoded into six chunks, it is appreciated that a data storage center employing switch-assisted data storage network traffic management in accordance with the present description, may employ other encoding schemes having encoding parameters other than k=4 and m=2 resulting in a different number or format of encoded chunks, depending upon the particular application.

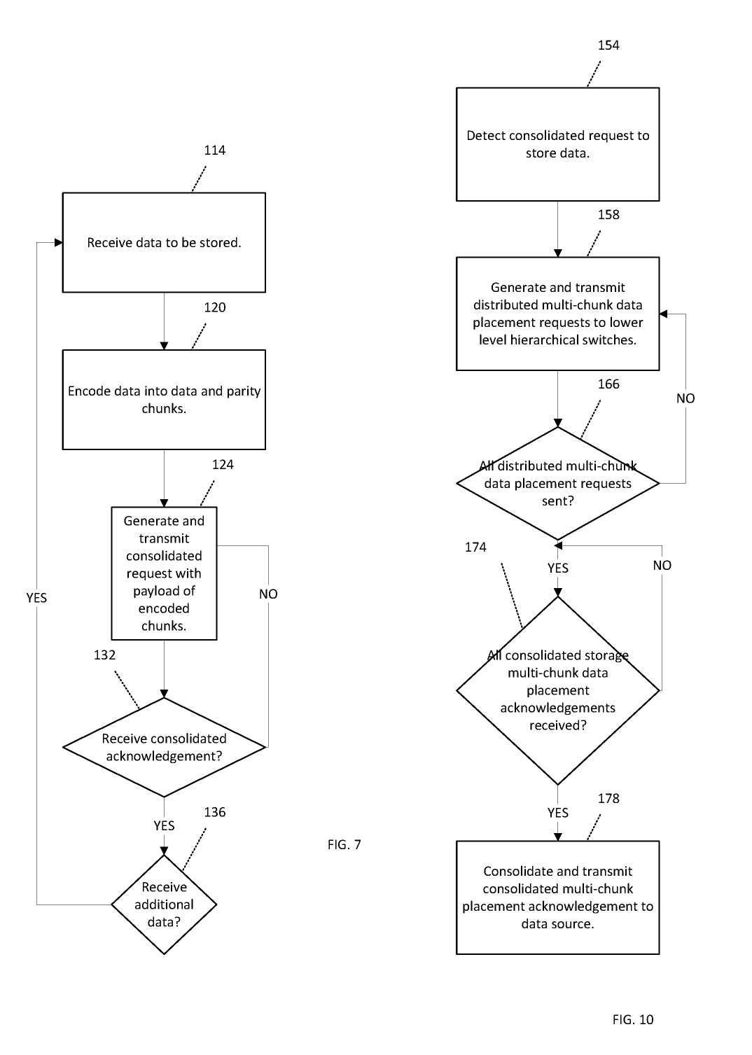

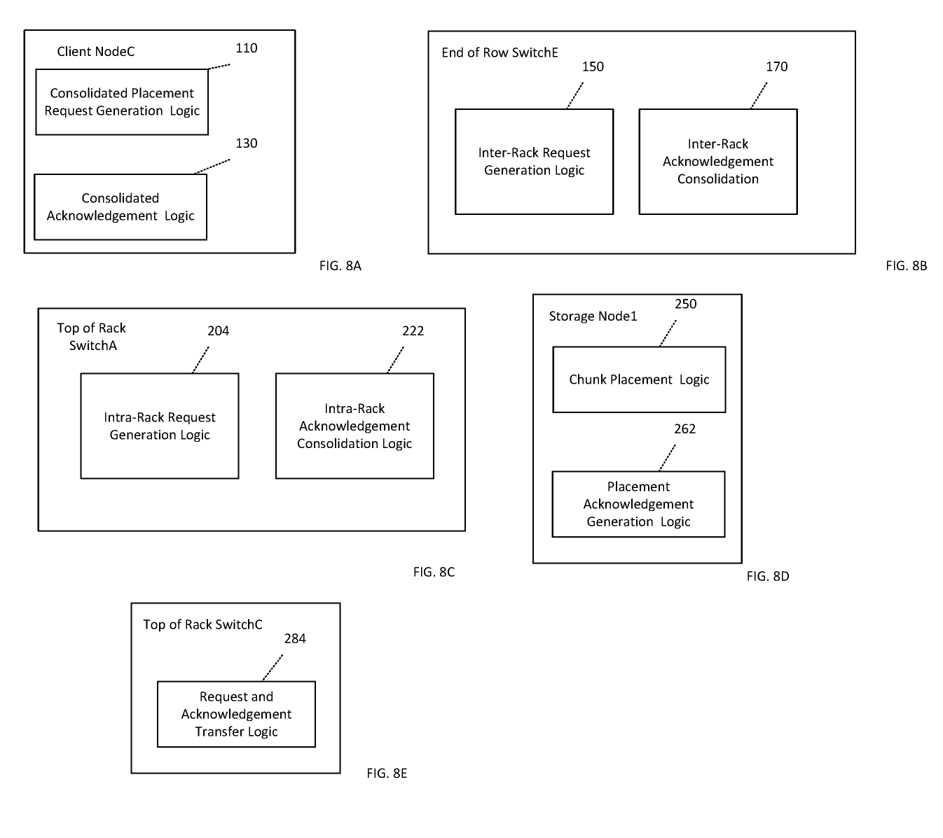

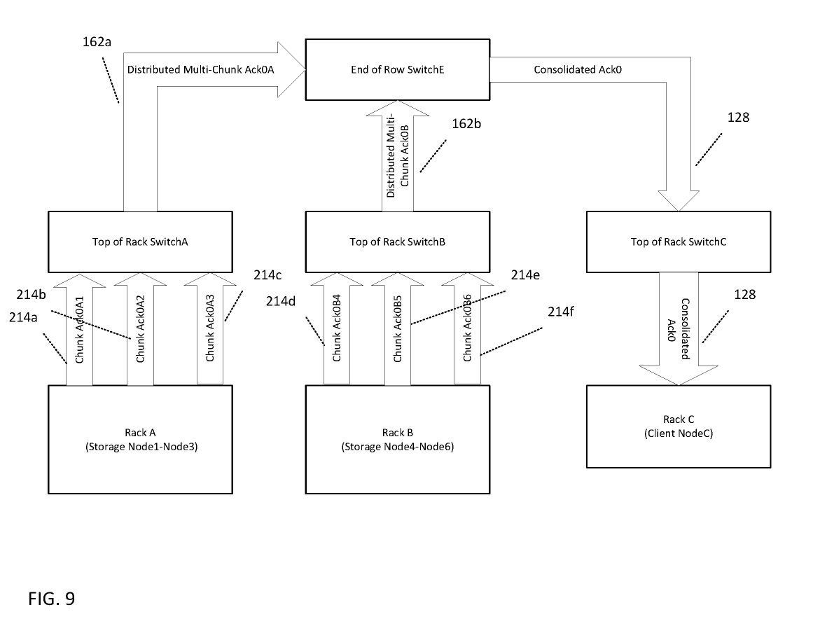

As explained in greater detail below in connection with FIG. 9, acknowledgements generated by placement of the encoded chunks in storage nodes may be consolidated as well to reduce network traffic and bandwidth requirements. Accordingly, consolidated acknowledgement logic 130 (FIG. 8A) is configured to determine (block 132, FIG. 7) whether such consolidated acknowledgements have been received. If additional data is received (block 136) for encoding and placement, the operations described above may be repeated for such additional data.

In the illustrated embodiment, the storage network depicted in FIG. 5 includes a hierarchical communication network which includes hierarchical top of rack switches, top of rack SwitchA-SwitchC, for racks, Rack A-Rack C, respectively, of the data storage system. The hierarchical top of rack switches, SwitchA-SwitchC, are at a common hierarchical level, and the end of row switch, SwitchE, is at a different, higher hierarchical level than that of the lower hierarchical top of rack switches, SwitchA-SwitchC.

In the illustrated embodiment, the client NodeC is configured to generate the initial consolidated data placement Request0. However, it is appreciated that such request generation may be performed by other nodes of the storage system. For example, one or more of the logic of the top of rack SwitchC, or the end of row SwitchE, for example, may be configured to generate an initial consolidated data placement, such as the initial consolidated data placement Request0.

FIG. 10 depicts one example of operations of the end of row SwitchE of FIG. 5. In one embodiment, the end of row SwitchE includes inter-rack request generation logic 150 configured to detect (block 154, FIG. 10) a consolidated multi-chunk placement request, such as the consolidated multi-chunk placement Request0, which has been received by the end of row SwitchE. In one embodiment, the consolidated placement Request0 may be addressed to the end of row hierarchical SwitchE. In another embodiment, the inter-rack request generation logic 150 be configured to monitor for and intercept a consolidated multi-chunk placement request, such as the consolidated multi-chunk placement Request0. As described above, the consolidated multi-chunk placement Request0 is a request to place the consolidated encoded chunks, Chunk1-Chunk6, in a defined set of storage nodes of the storage system. The inter-rack request generation logic 150 (FIG. 8B) is further configured to, in response to the consolidated multi-chunk placement Request0, generate (block 158, FIG. 10) and transmit distributed multi-chunk data placement requests to lower hierarchical switches.

It is appreciated herein that, from the perspective of the data center network topology, two factors in an EC(k, m) encoded redundancy scheme include an intra-rack EC chunk factor rᵢ and an inter-rack EC chunk factor R. The factor rᵢ describes how many EC encoded chunks are placed in the same rack i, whereas the factor R describes how many storage racks are holding these chunks. For a data storage system employing an EC(k, m) encoding scheme, the following holds true:

r=k+m=Σ rᵢ, where 1≤i≤R.

In the embodiment of FIG. 5, the inter-rack request generation logic 150 generates and transmits R distributed multi-chunk data placement requests where R=2 since there are two storage racks, Rack A and Rack B in the data storage system. Each distributed multi-chunk data placement request contains as payload n=3 encoded chunks since each rack such as the rack A is assigned three encoded chunks to store. Accordingly, the inter-rack request generation logic 150 generates and transmits a first distributed multi-chunk data placement Request0A to the first lower level hierarchical top of rack SwitchA to place a first set of encoded chunks, Chunk1-Chunk3, in respective assigned storage nodes, NodeA-NodeC, of storage Rack A. As shown in FIG. 11, the distributed multi-chunk data placement Request0A has payload fields 100a-100c containing the first set of encoded chunks, Chunk1-Chunk3, respectively, which were split from the consolidated multi-chunk placement Request0 and copied to the distributed multi-chunk data placement Request0A as shown in FIG. 11.

In one aspect of the present description, the inter-rack request generation logic 150 of the end of row SwitchE is configured to split encoded chunks from the consolidated multi-chunk placement Request0, and repackage them in a particular distributed multi-chunk data placement request such as the Request0A, as a function of the assigned storage nodes in which the encoded chunks of the consolidated multi-chunk placement Request0 are to be placed. In the example of FIGS. 5, 6 and 11, the consolidated multi-chunk placement Request0 requests placement of the encoded chunks, Chunk1-Chunk3, in the storage nodes, Node1-Node3, respectively, of storage rack A, as indicated by the storage node address fields 104a-104c, respectively, of the consolidated multi-chunk placement Request0. Hence, the inter-rack request generation logic 150 of the end of row SwitchE splits encoded chunks Chunk1-Chunk3 from the consolidated multi-chunk placement Request0, and repackages them in distributed multi-chunk data placement Request0A and transmits distributed multi-chunk data placement Request0A in a TCP/IP connection 162a (FIG. 5) to the lower hierarchical level top of rack SwitchA for storage Rack A which contains the assigned storage nodes, Node1-Node3, for the requested placement of encoded chunks, Chunk1-Chunk3.

The inter-rack request generation logic 150 is further configured to determine (block 166, FIG. 10) whether all distributed multi-chunk data placement requests have been sent to the appropriate lower level hierarchical switches. In the embodiment of FIG. 5, a second distributed multi-chunk data placement request is generated and transmitted to a lower level top of rack switch for a second storage rack, that is Rack B. Accordingly, in a manner similar to that described above in connection with the distributed multi-chunk data placement Request0A, the inter-rack request generation logic 150 generates and transmits a second distributed multi-chunk data placement Request0B (FIG. 5) to the second lower level hierarchical top of rack SwitchB to place a second set of encoded chunks, Chunk4-Chunk6, in respective assigned storage nodes, NodeD-NodeF, of storage Rack B. As shown in FIG. 11, the distributed multi-chunk data placement Request0B has payload fields 100d-100f containing the second set of encoded chunks, Chunk4-Chunk6, respectively, which were split from the consolidated multi-chunk placement Request0 and copied to the distributed multi-chunk data placement Request0B as shown in FIG. 11.

In the example of FIGS. 5, 6 and 11, the consolidated multi-chunk placement Request0 requests placement of the encoded chunks, Chunk4-Chunk6 in the storage nodes, Node4-Node6, respectively, of storage rack B, as indicated by the storage node address fields 104d-104f, respectively, of the consolidated multi-chunk placement Request0. Hence, the inter-rack request generation logic 150 of the end of row SwitchE splits encoded chunks Chunk4-Chunk6 from the consolidated multi-chunk placement Request0, and repackages them in distributed multi-chunk data placement Request0B and transmits distributed multi-chunk data placement Request0B in a consolidated TCP/IP connection 162b (FIG. 5) to the lower hierarchical level top of rack SwitchB for storage Rack B which contains the assigned storage nodes, Node4-Node6, for the requested placement of encoded chunks, Chunk4-Chunk6.

Thus, instead of three individual data placement requests for three separate encoded chunks transmitted in three individual TCP/IP connections between the end of row switch4 (FIG. 1) and the top of rack switch1 as described in connection with the prior system of FIG. 1, the inter-rack request and generation logic 150 (FIG. 8B) generates and transmits as few as a single consolidated placement request0A for three encoded chunks of data, in a single TCP/IP connection 162a (FIG. 5) between the end of row switchE and the top of rack SwitchA for the rack A. In a similar manner, instead of three individual data placement requests for three separate encoded chunks transmitted in three individual TCP/IP connections between the end of row switch4 (FIG. 1) and the top of rack switch2 as described in connection with the prior system of FIG. 1, the inter-rack request and generation logic 150 (FIG. 8B) generates and transmits as few as a single consolidated placement Request0B for three encoded chunks of data, in a single TCP/IP connection 162b (FIG. 5) between the end of row switch4 and the top of rack SwitchB for the rack B.

As explained in greater detail below in connection with FIG. 9, acknowledgements generated by placement of the encoded chunks in storage nodes may be consolidated as well to reduce network traffic and bandwidth requirements. Accordingly, inter-rack acknowledgment consolidation logic 170 (FIG. 8B) of the end of row SwitchE is further configured to determine (block 174, FIG. 10) whether combined acknowledgements have been received, and if so, to further consolidate (block 178) and transmit consolidated multi-chunk placement acknowledgements to the data source as described in connection with FIG. 9 below.

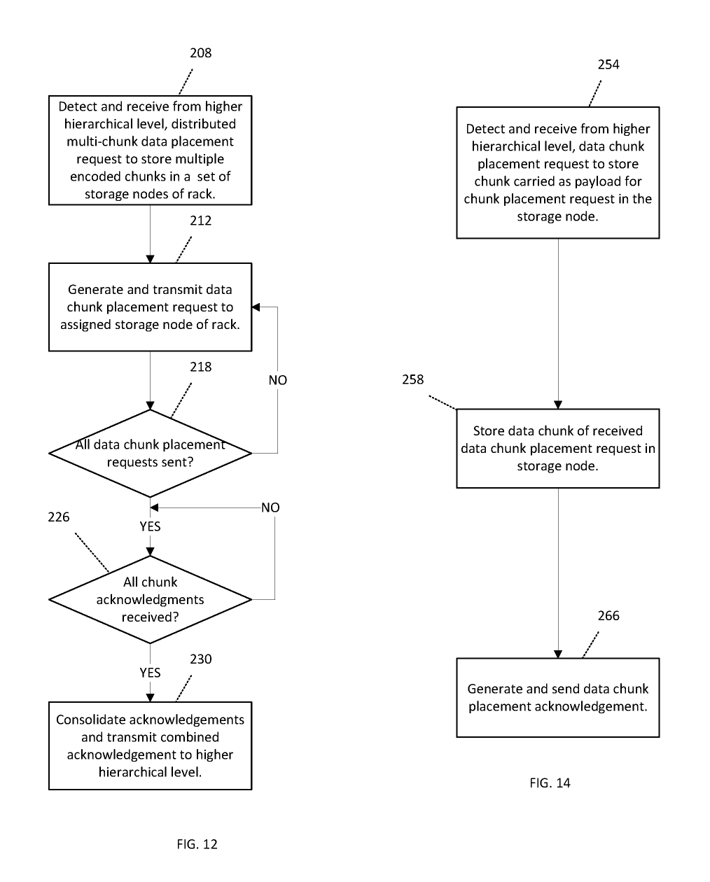

FIG. 12 depicts one example of operations of a top of rack switch such as the top of rack switch SwitchA and the top of rack SwitchB of FIG. 5. In one embodiment, the top of rack SwitchA, for example, includes intra-rack request generation logic 204 (FIG. 8C) configured to detect (block 208, FIG. 12) a distributed multi-chunk placement request, such as the distributed multi-chunk placement Request0A, which has been received by the top of rack SwitchA from the higher hierarchical level end of row SwitchE. In one embodiment, the distributed multi-chunk placement Request0A may be addressed to the top of rack SwitchA. In another embodiment, the intra-rack request generation logic 204 be configured to monitor for and intercept a consolidated multi-chunk placement request, such as the consolidated multi-chunk placement Request0A. As described above, the distributed multi-chunk placement Request0A is a request to place the consolidated encoded chunks, Chunk1-Chunk3, in a defined first set of storage nodes, Node1-Node3 of Rack A of the storage system. The intra-rack request generation logic 204 (FIG. 8C) is further configured to, in response to the detected distributed multi-chunk placement Request0A, generate (block 212, FIG. 12) and transmit data chunk placement requests to assigned storage nodes of the storage Rack A., wherein each chunk data placement request is a request to place an individual erasure encoded chunk of data in an assigned storage node of the first set of storage nodes.

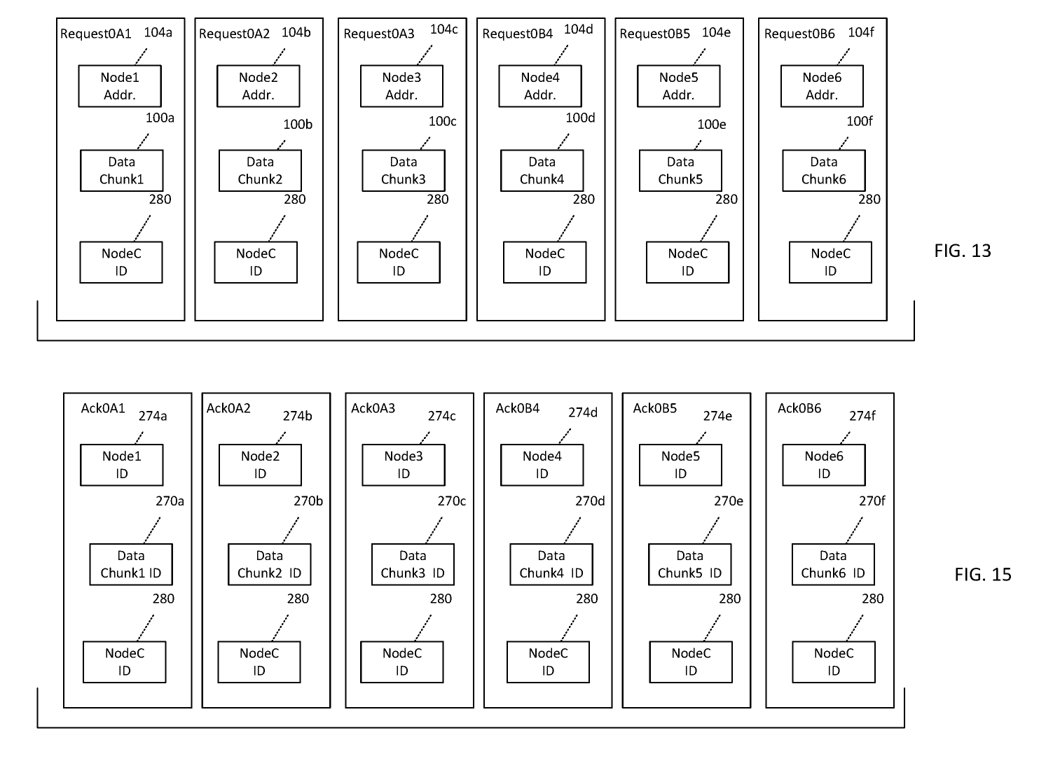

In the embodiment of FIG. 5, the intra-rack request generation logic 204 of top of rack SwitchA generates and transmits rᵢ=3 data chunk placement requests for the rack A since three encoded chunks are to be placed in each rack. in this embodiment. Accordingly, the intra-rack request generation logic 204 of the top of rack SwitchA generates and transmits a first data chunk placement Request0A1 to the first lower level hierarchical top of rack SwitchA to place a single encoded chunk, Chunk1, in the assigned storage NodeA of storage Rack A. As shown in FIG. 13, the data chunk placement Request0A1 has a payload field 100a containing the encoded chunk, Chunk1, which was split from the distributed multi-chunk placement Request0A and copied to the data chunk placement Request0A1 as shown in FIG. 13.

In one aspect of the present description, the intra-rack request generation logic 204 of the top of rack SwitchA is configured to split an encoded chunk from the distributed multi-chunk placement Request0A, and repackage it in a particular data chunk placement request such as the Request0A1, as a function of the assigned storage node in which the encoded chunk of the distributed multi-chunk placement Request0A is to be placed. In the example of FIGS. 5, 11 and 13, the distributed multi-chunk placement Request0A requests placement of the encoded chunk, Chunk1, in the storage node, Node1, of storage rack A, as indicated by the storage node address field 104a (FIG. 11), of the distributed multi-chunk placement Request0A. Hence, the intra-rack request generation logic 204 of the top of rack SwitchA splits encoded chunk Chunk1 from the consolidated multi-chunk placement Request0A, and repackages it in the payload field 100a (FIG. 13) of data chunk placement Request0A1 and transmits data chunk placement Request0A1 in a TCP/IP connection 214a (FIG. 5) to storage node Node1 of the storage rack A, for the requested placement of encoded chunk Chunk1 in storage Node1 as indicated by node address field 104a (FIG. 13), of data chunk placement Request0A1.

The intra-rack request generation logic 204 is further configured to determine (block 218, FIG. 12) whether all data chunk placement requests have been sent to the appropriate storage node of the associated storage rack. In the embodiment of FIG. 5, two additional data chunk placement requests, Request0A2 and Request0A3, are generated and transmitted by intra-rack request generation logic 204 of the top of rack SwitchA, to the storage nodes Node2 and Node3, respectively, of the storage Rack A in a manner similar to that described above in connection with the data chunk placement Request0A1. Data chunk placement requests, Request0A2 and Request0A3, request placement of encoded chunks, Chunk2 and Chunk3, respectively, contained in payload fields 100b and 100c (FIG. 13), respectively, of data chunk placement requests, Request0A2 and Request0A3, respectively, in storage nodes, Node2 and Node3, respectively, as addressed by node address fields 104b and 104c (FIG. 13), respectively, of data chunk placement requests, Request0A2 and Request0A3, respectively. Data chunk placement requests, Request0A2 and Request0A3, are transmitted to the storage nodes, Node2 and Node3, respectively, in TCP/IP connections 214b and 214c, respectively.

In the embodiment of FIG. 5, three additional data chunk placement requests, Request0B4, Request0B5 and Request0B6, are generated and transmitted in response to the detected distributed multi-chunk placement Request0B from the end of rack SwitchE. The three additional data chunk placement requests, Request0B4, Request0B5 and Request0B6, are generated and transmitted by intra-rack request generation logic 204 of the top of rack SwitchB, to the storage nodes Node4, Node5 and Node6, respectively, of the storage Rack B in a manner similar to that described above in connection with the data chunk placement requests, Request0A1-Request0A3. Data chunk placement requests, Request0B4, Request0B5 and Request0B6, request placement of encoded chunks, Chunk4, Chunk5 and Chunk6, respectively, contained in payload fields 100d, 100e and 100f (FIG. 13), respectively, of data chunk placement requests, Request0B4, Request0B5 and Request0B6, respectively, in storage nodes, Node4, Node5 and Node6, as addressed by node address fields 104d, 104e, 104f (FIG. 13), respectively, of data chunk placement requests, Request0B4, Request0B5 and Request0B6, respectively. Data chunk placement requests, Request0B4, Request0B5 and Request0B6, are transmitted to the storage nodes, Node4, Node5 and Node6, respectively, in TCP/IP connections 214d, 214e and 214f, respectively. Data chunk placement requests, Request0B1, Request0B2 and Request0B3, are transmitted to the storage nodes, Node4, Node5 and Node6, respectively, in TCP/IP connections 214d, 214e and 214f, respectively.

Intra-rack acknowledgment consolidation logic 222 (FIG. 8C) of each of the top of rack SwitchA and the top of rack SwitchB are each configured to determine (block 226, FIG. 12) whether all storage acknowledgements have been received from the storage nodes of the associated storage racks. If the acknowledgements have been received, the intra-rack acknowledgment consolidation logic 222 (FIG. 8C) is further configured to combine or consolidate (block 230) and transmit consolidated multi-chunk placement acknowledgements to the data source as described in connection with FIG. 9 below.

FIG. 14 depicts one example of operations of a storage node of the storage nodes, Node1-Node6 of the racks, Rack A and Rack B, of FIG. 5. In one embodiment, the storage Node1, for example, includes data chunk placement logic 250 (FIG. 8D) configured to detect (block 254, FIG. 14) a data chunk placement request received from a higher hierarchical level such as the hierarchical level of the top of rack SwitchA. The chunk placement logic 250 is further configured to, in response to receipt of a data chunk placement request, store (block 258, FIG. 14) the data chunk contained in the payload of the data chunk placement request in the storage node if the storage node is the storage node assigned for placement of the data chunk by the received data chunk placement request.

In one embodiment, the storage node which receives a data chunk placement request addressed to the storage node by a storage node address field such as the address field 104a of a data chunk placement Request0A1, for example, in a TCP/IP connection such as the connection 214a, for example, that receiving storage node may assume that it is the assigned storage node of the received data chunk placement request. In other embodiments, the receiving storage node may confirm that it is the assigned storage node of the received data chunk placement request by inspecting the storage node address field 104a of a received data chunk placement Request0A1, for example, and comparing the assigned address to the address of the receiving storage node.

Upon successfully storing the data Chunk1 contained in the payload field 100a of the received data chunk placement Request0A1, placement acknowledgement generation logic 262 (FIG. 8D) of the assigned storage node, Node1 in this example, generates (block 266, FIG. 14) and sends an acknowledgement, data chunk acknowledgement Ack0A1 (FIGS. 9, 15) acknowledging successful placement of the data chunk, Chunk1 in this example, in the storage Node1. In the embodiment of FIG. 5, each of the other storage nodes, Node2-Node6, upon successfully storing the respective data chunk of data Chunk2-Chunk6, respectively, contained in the respective payload field of payload fields 100b-100f, respectively, of the received respective data chunk placement request of data chunk placement Request0A2-Request0A3, and Request0B4-Request0B6, respectively, cause placement acknowledgement generation logic 262 (FIG. 8D) of the assigned respective storage node of storage Node2-Node6, respectively, to generate (block 266) and send an acknowledgement, data chunk acknowledgements Ack0A2-Ack0A3, Ack0B4-Ack0B6, respectively (FIGS. 9, 15), acknowledging successful placement of the respective data chunk of Chunk2-Chunk6, in the respective node of storage Node2-Node6, respectively. As shown in FIG. 15, each data chunk acknowledgement Ack0A1-Ack0A3, Ack0B4-Ack0B6 may, in one embodiment, include a data chunk identification field 270a-270f, respectively, to identify the data chunk for which data chunk storage is being acknowledged, a node identification field 274a-274f, respectively, to identify the particular storage node for which data chunk storage is being acknowledged, and a client node identification field 280 to identify the client node such as client NodeC, for example, which is the source of the data placement request being acknowledged. In one embodiment, each data placement request, Request0 (FIG. 6), Request0A-Request0B (FIG. 11), Request0A1-Request0B6 (FIG. 13) may also include a client node identification field 280 to identify the client node such as client NodeC, for example, which is the original source of the data placement Request0 being directly or indirectly acknowledged.

Referring to FIG. 9, each of the hierarchical top of rack switches, SwitchA and SwitchB, has intra-rack acknowledgement consolidation logic 222 (FIG. 8C) configured to receive (block 226, FIG. 12) a plurality of data chunk placement acknowledgments, each data chunk placement acknowledgment acknowledging storage of an individual erasure encoded chunk of data in an assigned storage node. In one embodiment, the data chunk placement acknowledgments may be addressed to the top of rack SwitchA. In another embodiment, the intra-rack acknowledgement consolidation logic 222 may be configured to monitor for and intercept the data chunk placement acknowledgments, such as the data chunk placement acknowledgments Ack0A1-Ack0A3. In addition, each intra-rack acknowledgement consolidation logic 222, consolidates (block 230, FIG. 12) the received data chunk acknowledgements, and generates and transmits to a higher level hierarchical switch, end of row SwitchE in the embodiment of FIG. 9, a multi-chunk data placement acknowledgement which acknowledges storage of multiple chunks of data in storage nodes of the storage system.

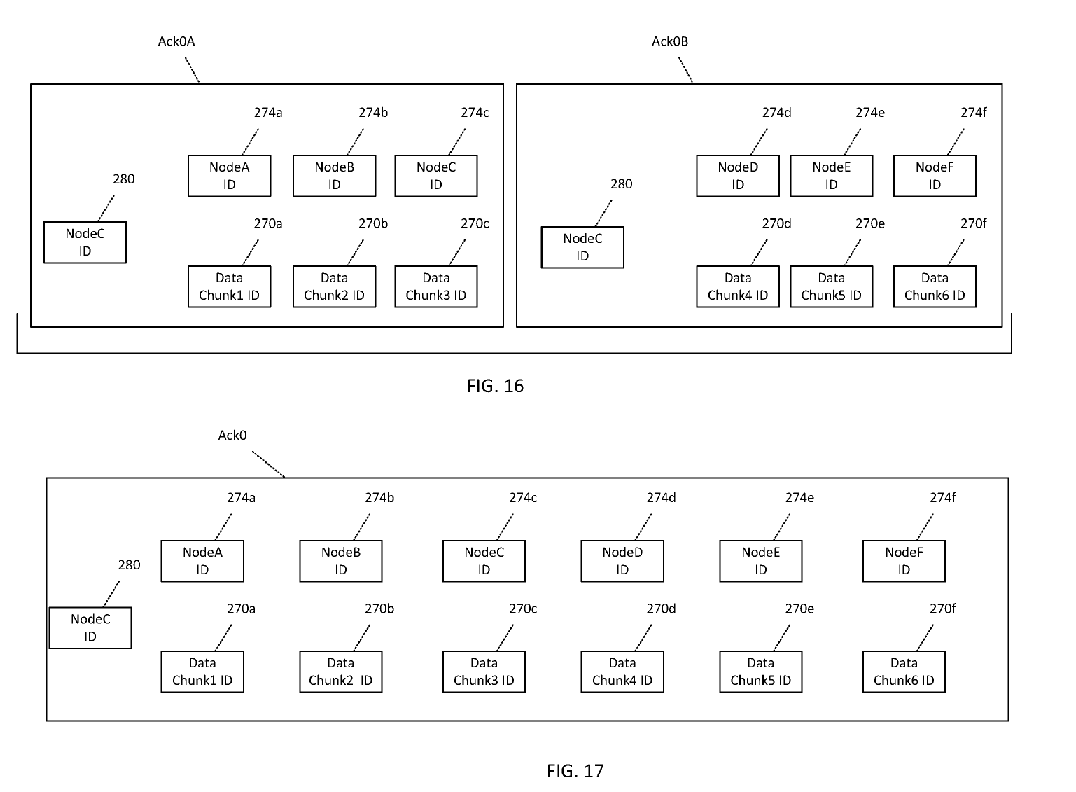

Thus, in the embodiment of FIG. 9, the hierarchical top of rack SwitchA for the Rack A has intra-rack acknowledgement consolidation logic 222 (FIG. 8C) which receives over three TCP/IP connections 214a-214c, the three chunk placement acknowledgements, Chunk Ack0A1-Ack0A3 (FIGS. 9, 15), respectively, each data chunk placement acknowledgment acknowledging storage of an individual erasure encoded chunk of data of the chunks Chunk1-Chunk3, respectively, as identified by data chunk ID fields 270a-270c (FIG. 15), respectively, in an assigned storage node of the first set of storage nodes of the storage nodes, Node1-Node3, respectively, as identified by storage node ID fields 274a-274c, respectively, of the chunk placement acknowledgements, Chunk Ack0A1-Ack0A3 (FIGS. 9, 15), respectively. The intra-rack acknowledgement consolidation logic 222 (FIG. 8C) of the hierarchical top of rack SwitchA consolidates the chunk placement acknowledgements, Chunk Ack0A1-Ack0A3 (FIGS. 9, 15), and generates and transmits over a single consolidated TCP/IP connection 162a, to the higher level hierarchical end of row SwitchE (FIG. 9) in response to receipt of the chunk placement acknowledgements, Chunk Ack0A1-Ack0A3 (FIGS. 9, 15), a first multi-chunk data placement acknowledgement Ack0A (FIGS. 9, 16) acknowledging storage of encoded chunks. More specifically, the multi-chunk data placement acknowledgement Ack0A (FIGS. 9, 16) acknowledges storage of encoded chunks, Chunk1-Chunk3, as identified by data chunk ID fields 270a-270c, respectively, of acknowledgement Ack0A, in the assigned Rack A storage nodes, Node1-Node3, respectively, as identified by the node ID fields 274a-274c, respectively, of acknowledgement Ack0A.

Similarly, in the embodiment of FIG. 9, the hierarchical top of rack SwitchB for the Rack B has intra-rack acknowledgement consolidation logic 222 (FIG. 8C) which receives over three TCP/IP connections 214d-214f, the three chunk placement acknowledgements, Chunk Ack0B4-Ack0B6 (FIGS. 9, 15), respectively, each data chunk placement acknowledgment, acknowledging storage of an individual erasure encoded chunk of data of the chunks Chunk4-Chunk6, respectively, as identified by data chunk ID fields 270d-270f (FIG. 15), respectively, in an assigned storage node of the second set of storage nodes of the storage nodes, Node4-Node6, respectively, as identified by storage node ID fields 274d-274f, respectively, of the chunk placement acknowledgements, Chunk Ack0B4-Ack0B6 (FIGS. 9, 15), respectively. The intra-rack acknowledgement consolidation logic 222 (FIG. 8C) of the hierarchical top of rack SwitchB consolidates the chunk placement acknowledgements, Chunk Ack0B4-Ack0B6 (FIGS. 9, 15), and generates and transmits to the higher level hierarchical end of row SwitchE (FIG. 9) in response to receipt of the chunk placement acknowledgements, Chunk Ack0B4-Ack0B6 (FIGS. 9, 15), a second multi-chunk data placement acknowledgement Ack0B (FIGS. 9, 16) acknowledging storage of encoded chunks. More specifically, the multi-chunk data placement acknowledgement Ack0B (FIGS. 9, 16) acknowledges storage of encoded chunks, Chunk4-Chunk6, as identified by data chunk ID fields 270d-270f, respectively, of acknowledgement Ack0B, in the assigned Rack B storage nodes, Node4-Node6, respectively, as identified by the node ID fields 274d-274f, respectively, of acknowledgement Ack0B.

Thus, instead of three individual chunk placement acknowledgements separately acknowledging three separate encoded chunk placements and transmitted in three individual TCP/IP connections between the top of rack Switch1 (FIG. 4) and the end of row Switch4 as described in connection with the prior system of FIG. 4, the intra-rack acknowledgement consolidation logic 222 (FIG. 8C) of the top of rack SwitchA (FIG. 9) generates and transmits as few as a single multi-chunk placement acknowledgment Ack0A acknowledging placement of three encoded chunks of data, in a single TCP/IP connection 162a (FIG. 9) between the top of rack SwitchA for the Rack A and the end of row SwitchE. In a similar manner, instead of three individual chunk placement acknowledgements separately acknowledging three separate encoded chunk placements and transmitted in three individual TCP/IP connections between the top of rack Switch2 (FIG. 4) and the end of row Switch4 as described in connection with the prior system of FIG. 4, the intra-rack acknowledgement consolidation logic 222 (FIG. 8C) of the top of rack SwitchB (FIG. 9) for rack B generates and transmits as few as a single multi-chunk placement acknowledgment Ack0B acknowledging placement of three encoded chunks of data, in a single TCP/IP connection 162b (FIG. 9) between the top of rack SwitchB for rack B and the end of row SwitchE. Thus, the intra-rack acknowledgement consolidation logic 222 (FIG. 8C) of the top of rack SwitchA (FIG. 9) for rack A, together with the intra-rack acknowledgement consolidation logic 222 (FIG. 8C) of the top of rack SwitchB (FIG. 9) for rack B, consolidate the chunk data placement acknowledgements to R=2 multi-chunk placement acknowledgments, Ack0A and Ack0B. As a result, network traffic for routing acknowledgements may be reduced.

In another aspect, the end of row SwitchE has inter-rack acknowledgment consolidation logic 170 (FIG. 8B) configured to receive (block 174, FIG. 10) consolidated multi-chunk data placement acknowledgements and further consolidate (block 178, FIG. 10) the received acknowledgements and generate and transmit to the client node of the storage system, a further consolidated multi-chunk placement acknowledgment acknowledging storage of the multiple encoded chunks of the original consolidated placement Request0, in the assigned storage nodes of the storage racks, Rack A and Rack B

Thus, in the embodiment of FIG. 9, the inter-rack acknowledgment consolidation logic 170 (FIG. 8B) of the hierarchical end of row SwitchE receives over two TCP/IP connections 162a-162b, the two multi-chunk placement acknowledgements, Ack0A and Ack0B, respectively. More specifically, the multi-chunk data placement acknowledgement Ack0A (FIGS. 9, 16) acknowledges storage of encoded chunks, Chunk1-Chunk3, as identified by data chunk ID fields 270a-270c, respectively, of acknowledgement Ack0A, in the assigned Rack A storage nodes, Node1-Node3, respectively, as identified by the node ID fields 274a-274c, respectively, of acknowledgement Ack0A. Similarly, the multi-chunk data placement acknowledgement Ack0B (FIGS. 9, 16) acknowledges storage of encoded chunks, Chunk4-Chunk6, as identified by data chunk ID fields 270d-270f, respectively, of acknowledgement Ack0B, in the assigned Rack B storage nodes, Node4-Node6, respectively, as identified by the node ID fields 274d-274f, respectively, of acknowledgement Ack0B. In one embodiment, the multi-chunk data placement acknowledgements Ack0A, Ack0B may be addressed to the end of row SwitchE. In another embodiment, the inter-rack acknowledgement consolidation logic 170 may be configured to monitor for and intercept the multi-chunk data placement acknowledgements, such as the data chunk placement acknowledgments Ack0A, Ack0B.

The inter-rack acknowledgment consolidation logic 170 (FIG. 8B) in response to the two multi-chunk placement acknowledgements, Ack0A and Ack0B, consolidates the two multi-chunk placement acknowledgements, Ack0A and Ack0B, and generates and transmits over a single consolidated TCP/IP connection 128, via the top of rack SwitchC, to the client NodeC of the RackC, a further consolidated multi-chunk data placement acknowledgement Ack0 (FIGS. 9, 17) acknowledging storage of encoded chunks. More specifically, the multi-chunk data placement acknowledgement Ack0 (FIGS. 9, 17) acknowledges storage of encoded chunks, Chunk1-Chunk6, as identified by data chunk ID fields 270a-270f, respectively, of acknowledgement Ack0, in the assigned storage nodes, Node1-Node6, respectively, as identified by the node ID fields 274a-274f, respectively, of acknowledgement Ack0.

Thus, instead of six individual chunk placement acknowledgements separately acknowledging six separate encoded chunk placements and transmitted in six individual TCP/IP connections between the end of row Switch4 (FIG. 4) and the client node of the Rack3 as described in connection with the prior system of FIG. 4, the inter-rack acknowledgment consolidation logic 170 (FIG. 8B) of the hierarchical end of row SwitchE (FIG. 9) generates and transmits as few as a single multi-chunk placement acknowledgment Ack0 acknowledging placement of six encoded chunks of data, in a single TCP/IP connection 128 (FIG. 9) between the end of row SwitchE and the client node of Rack C. In one embodiment, the multi-chunk data placement acknowledgement Ack0 may be addressed to the client NodeC. In another embodiment, the acknowledgement consolidation logic 130 may be configured to monitor for and intercept a multi-chunk data placement acknowledgement, such as the data placement acknowledgments Ack0. As a result, network traffic for routing acknowledgements may be reduced.

As shown in FIG. 8E, the top of rack SwitchC includes request and acknowledgement transfer logic 284 which is configured to transfer the original consolidated data placement Request0 (FIG. 5) from the originating client NodeC of Rack C, to the end of row SwitchE, via TCP/IP connection 128. In a similar manner, the request and acknowledgement transfer logic 284 is further configured to transfer the consolidated data placement acknowledgement Ack0 (FIG. 9) from the end of row SwitchE to the data placement request originating client NodeC of Rack C, via TCP/IP connection 128. In this manner, the originated client NodeC is notified that the encoded chunks Chunk1-Chunk6 of the original consolidated data placement Request0, have been successfully stored in the assigned storage Node1-Node3 of Rack A and storage Node4-Node6 of Rack B, respectively.

Such components in accordance with embodiments described herein can be used either in stand-alone memory components, or can be embedded in microprocessors and/or digital signal processors (DSPs). Additionally, it is noted that although systems and processes are described herein primarily with reference to microprocessor based systems in the illustrative examples, it will be appreciated that in view of the disclosure herein, certain aspects, architectures, and principles of the disclosure are equally applicable to other types of device memory and logic devices.

Implementations of the described techniques may include hardware, a method or process, or computer software on a computer-accessible medium. Thus, embodiments include corresponding computer systems, apparatus, and computer programs recorded on one or more computer storage devices, each configured to perform the actions of the methods.

Operations described herein are performed by logic which is configured to perform the operations either automatically or substantially automatically with little or no system operator intervention, except where indicated as being performed manually such as user selection. Thus, as used herein, the term “automatic” includes both fully automatic, that is operations performed by one or more hardware or software controlled machines with no human intervention such as user inputs to a graphical user selection interface. As used herein, the term “automatic” further includes predominantly automatic, that is, most of the operations (such as greater than 50%, for example) are performed by one or more hardware or software controlled machines with no human intervention such as user inputs to a graphical user selection interface, and the remainder of the operations (less than 50%, for example) are performed manually, that is, the manual operations are performed by one or more hardware or software controlled machines with human intervention such as user inputs to a graphical user selection interface to direct the performance of the operations.

Many of the functional elements described in this specification have been labeled as “logic,” in order to more particularly emphasize their implementation independence. For example, a logic element may be implemented as a hardware circuit comprising custom Very Large Scale Integrated (VLSI) circuits or gate arrays, off-the-shelf semiconductors such as logic chips, transistors, or other discrete components. A logic element may also be implemented in firmware or programmable hardware devices such as field programmable gate arrays, programmable array logic, programmable logic devices or the like.

A logic element may also be implemented in software for execution by various types of processors. A logic element which includes executable code may, for instance, comprise one or more physical or logical blocks of computer instructions which may, for instance, be organized as an object, procedure, or function. Nevertheless, the executables of an identified logic element need not be physically located together, but may comprise disparate instructions stored in different locations which, when joined logically together, comprise the logic element and achieve the stated purpose for the logic element.

Indeed, executable code for a logic element may be a single instruction, or many instructions, and may even be distributed over several different code segments, among different programs, among different processors, and across several non-volatile memory devices. Similarly, operational data may be identified and illustrated herein within logic elements, and may be embodied in any suitable form and organized within any suitable type of data structure. The operational data may be collected as a single data set, or may be distributed over different locations including over different storage devices.

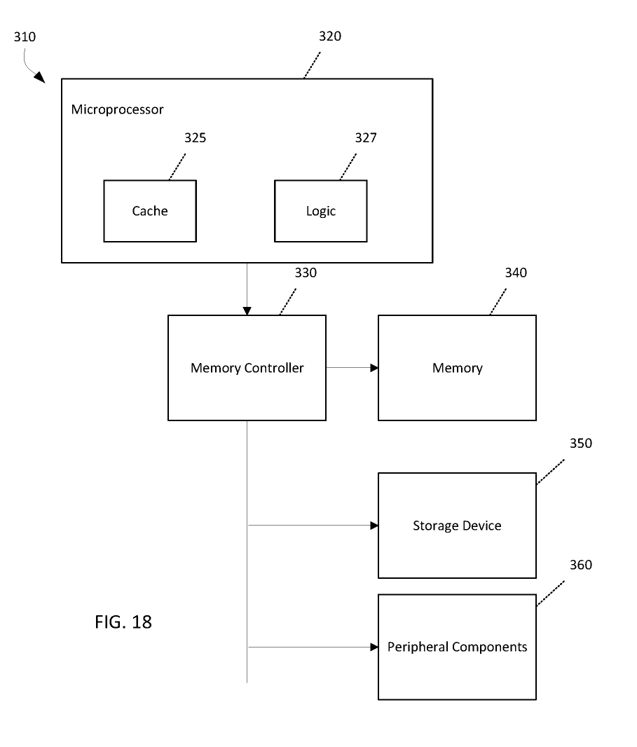

FIG. 18 is a high-level block diagram illustrating selected aspects of a node represented as a system 310 implemented according to an embodiment of the present disclosure. System 310 may represent any of a number of electronic and/or computing devices, that may include a memory device. Such electronic and/or computing devices may include computing devices such as a mainframe, server, personal computer, workstation, telephony device, network appliance, virtualization device, storage controller, portable or mobile devices (e.g., laptops, netbooks, tablet computers, personal digital assistant (PDAs), portable media players, portable gaming devices, digital cameras, mobile phones, smartphones, feature phones, etc.) or component (e.g. system on a chip, processor, bridge, memory controller, memory, etc.). In alternative embodiments, system 310 may include more elements, fewer elements, and/or different elements. Moreover, although system 310 may be depicted as comprising separate elements, it will be appreciated that such elements may be integrated on to one platform, such as systems on a chip (SoCs). In the illustrative example, system 310 comprises a central processing unit or microprocessor 320, a memory controller 330, a memory 340, a storage drive 344 and peripheral components 350 which may include, for example, video controller, input device, output device, additional storage, network interface or adapter, battery, etc.

The microprocessor 320 includes a cache 325 that may be part of a memory hierarchy to store instructions and data, and the system memory may include both volatile memory as well as the memory 340 depicted which may include a non-volatile memory. The system memory may also be part of the memory hierarchy. Logic 327 of the microprocessor 320 may include one or more cores, for example. Communication between the microprocessor 320 and the memory 340 may be facilitated by the memory controller (or chipset) 330, which may also facilitate in communicating with the storage drive 344 and the peripheral components 350. The system may include an offload data transfer engine for direct memory data transfers.

Storage drive 344 includes non-volatile storage and may be implemented as, for example, solid-state drives, magnetic disk drives, optical disk drives, storage area network (SAN), network access server (NAS), a tape drive, flash memory, persistent memory domains and other storage devices employing a volatile buffer memory and a nonvolatile storage memory. The storage may comprise an internal storage device or an attached or network accessible storage. The microprocessor 320 is configured to write data in and read data from the memory 340. Programs in the storage are loaded into the memory 340 and executed by the microprocessor 320. A network controller or adapter enables communication with a network, such as an Ethernet, a Fiber Channel Arbitrated Loop, etc. Further, the architecture may, in certain embodiments, include a video controller configured to render information on a display monitor, where the video controller may be embodied on a video card or integrated on integrated circuit components mounted on a motherboard or other substrate. An input device is used to provide user input to the microprocessor 320, and may include a keyboard, mouse, pen-stylus, microphone, touch sensitive display screen, input pins, sockets, or any other activation or input mechanism known in the art. An output device is capable of rendering information transmitted from the microprocessor 320, or other component, such as a display monitor, printer, storage, output pins, sockets, etc. The network adapter may be embodied on a network card, such as a peripheral component interconnect (PCI) card, PCI-express, or some other input/output (I/O) card, or on integrated circuit components mounted on a motherboard or other substrate.

One or more of the components of the device 310 may be omitted, depending upon the particular application. For example, a network router may lack a video controller, for example. Any one or more of the devices of FIG. 1 including the cache 325, memory 340, storage drive 344, system 10, memory controller 330 and peripheral components 350, may include a nonvolatile storage memory component having an internal data preservation and recovery in accordance with the present description.

### EXAMPLES

Example 1 is an apparatus for use with a hierarchical communication network of a storage system having a plurality of storage nodes configured to store data, comprising:

a first hierarchical switch at a first hierarchical level in the hierarchical communication network of the storage system, the first hierarchical switch having intra-rack request generation logic configured to detect receipt of a first distributed multi-chunk data placement request to place first storage data in a first set of storage nodes of the storage system, and in response to the first distributed multi-chunk data placement request, generate and transmit a first set of data chunk placement requests to assigned storage nodes of the first set of storage nodes, wherein each data chunk placement request is a request to place an individual erasure encoded chunk of data of the first storage data, in an assigned storage node of the first set of storage nodes.

In Example 2, the subject matter of Examples 1-8 (excluding the present Example) can optionally include:

a second hierarchical switch at the first hierarchical level in the hierarchical communication network of the storage system, the second hierarchical switch having intra-rack request generation logic configured to detect receipt of a second distributed multi-chunk data placement request to place second storage data in a second set of storage nodes of the storage system, and in response to the second distributed multi-chunk data placement request, generate and transmit a second set of data chunk placement requests to assigned storage nodes of the second set of storage nodes, wherein each data chunk placement request of the second set is a request to place an individual erasure encoded chunk of data of the second storage data, in an assigned storage node of the second set of storage nodes.

In Example 3, the subject matter of Examples 1-8 (excluding the present Example) can optionally include wherein the first hierarchical level of the first and second hierarchical switches is at a lower hierarchical level as compared to a second hierarchical level of the hierarchical communication network of the storage system, the apparatus further comprising:

a third hierarchical switch at the second hierarchical level, the third hierarchical switch having inter-rack request generation logic configured to detect a consolidated multi-chunk placement request to place storage data including the first and second storage data, in storage in a set of storage nodes of the storage system including the first and second sets of storage nodes, and in response to the consolidated multi-chunk placement request, generate and transmit the first distributed multi-chunk data placement request to the first hierarchical switch to place the first storage data in the first set of storage nodes of the storage system, and the second distributed multi-chunk data placement request to the second hierarchical switch to place the second storage data in the second set of storage nodes of the storage system.

In Example 4, the subject matter of Examples 1-8 (excluding the present Example) can optionally include:

a client node coupled to the third hierarchical switch, and having consolidated placement request logic configured to receive storage data including the first and second storage data, erasure encode the received data into chunks of erasure encoded chunks of the first and second storage data, at least some of which include parity data, and generate and transmit to the third hierarchical switch, the consolidated multi-chunk placement request having a payload of erasure encoded chunks of the first and second storage data, for storage in the first and second sets of storage nodes, respectively.

In Example 5, the subject matter of Examples 1-8 (excluding the present Example) can optionally include:

a first storage rack having the first set of storage nodes, each storage node of the first set having chunk placement logic configured to, in response to a data chunk placement request of the first set of data chunk placement requests, received by the assigned storage node of the first set of storage nodes, store an individual erasure encoded chunk of data of the first set of erasure encoded chunks of data, each storage node of the first set further having placement acknowledgement generation logic configured to send to the first hierarchical switch a data chunk placement acknowledgment acknowledging storage of an individual erasure encoded chunk of data of the first set of erasure encoded chunks of data,
wherein the first hierarchical switch has intra-rack acknowledgement consolidation logic configured to receive a first plurality of data chunk placement acknowledgments, each data chunk placement acknowledgment acknowledging storage of an individual erasure encoded chunk of data of the first set of erasure encoded chunks of data in an assigned storage node of the first set of storage nodes, and generate and transmit to the third switch in response to receipt of the first plurality of data chunk placement acknowledgments, a first multi-chunk data placement acknowledgement acknowledging storage of the first storage data in the first set of storage nodes of the storage system,

a second storage rack having the second set of storage nodes, each storage node of the second set having chunk placement logic configured to, in response to a data chunk placement request of the second set of data chunk placement requests, received by the assigned storage node of the second set of storage nodes, store an individual erasure encoded chunk of data of the second set of erasure encoded chunks of data, each storage node of the second set further having placement acknowledgement generation logic configured to send to the second hierarchical switch a data chunk placement acknowledgment acknowledging storage of an individual erasure encoded chunk of data of the second set of erasure encoded chunks of data,

wherein the second hierarchical switch has intra-rack acknowledgement consolidation logic configured to receive a second plurality of data chunk placement acknowledgments, each data chunk placement acknowledgment acknowledging storage of an individual erasure encoded chunk of data of the second set of erasure encoded chunks of data in an assigned storage node of the second set of storage nodes, and generate and transmit to the third switch in response to receipt of the second plurality of data chunk placement acknowledgments, a second multi-chunk data placement acknowledgement acknowledging storage of the second storage data in the second set of storage nodes of the storage system.

In Example 6, the subject matter of Examples 1-8 (excluding the present Example) can optionally include wherein the third hierarchical switch has inter-rack acknowledgment consolidation logic configured to receive the first and second multi-chunk data placement acknowledgements and generate and transmit to the client node of the storage system, a consolidated multi-chunk placement acknowledgment acknowledging storage of the first and second storage data in the first and second sets, respectively, of storage nodes of the storage system.

In Example 7, the subject matter of Examples 1-8 (excluding the present Example) can optionally include wherein the intra-rack request generation logic is further configured to erasure encode the first storage data of the first distributed multi-chunk data placement request received by the first hierarchical switch, to the erasure encoded chunks of data for the first set of data chunk placement requests to place the individual erasure encoded chunks of data of the first storage data, in assigned storage nodes of the first set of storage nodes.

In Example 8, the subject matter of Examples 1-8 (excluding the present Example) can optionally include said storage system having said hierarchical communication network.

Example 9 is a method, comprising:

detecting by a first hierarchical switch at a first hierarchical level in a hierarchical communication network of a storage system, a first distributed multi-chunk data placement request to place first storage data in a first set of storage nodes of the storage system, and

in response to the first distributed multi-chunk data placement request, transmitting by the first hierarchical switch, a first set of data chunk placement requests to assigned storage nodes of the first set of storage nodes, wherein each data chunk placement request is a request to place an individual erasure encoded chunk of data of the first storage data, in an assigned storage node of the first set of storage nodes.

In Example 10, the subject matter of Examples 9-15 (excluding the present Example) can optionally include:

detecting by a second hierarchical switch at the first hierarchical level in a hierarchical communication network of a storage system, a second distributed multi-chunk data placement request to place second storage data in a second set of storage nodes of the storage system, and

in response to the second distributed multi-chunk data placement request, transmitting by the second hierarchical switch, a second set of data chunk placement requests to assigned storage nodes of the second set of storage nodes, wherein each data chunk placement request of the second set of data chunk placement requests is a request to place an individual erasure encoded chunk of data of the second storage data, in an assigned storage node of the second set of storage nodes.

In Example 11, the subject matter of Examples 9-15 (excluding the present Example) can optionally include wherein the first hierarchical level of the first and second hierarchical switches is at a lower hierarchical level as compared to a second hierarchical level of a third hierarchical switch in the hierarchical communication network of the storage system, the method further comprising:

detecting by the third hierarchical switch, a consolidated multi-chunk placement request to place storage data including the first and second storage data, in storage in a set of storage nodes of the storage system including the first and second sets of storage nodes,

in response to the consolidated multi-chunk placement request, transmitting by the third hierarchical switch, the first distributed multi-chunk data placement request to the first hierarchical switch to place the first storage data in the first set of storage nodes of the storage system, and

in response to the third transmission of data, transmitting by the third hierarchical switch, the second distributed multi-chunk data placement request to the second hierarchical switch to place the second storage data in the second set of storage nodes of the storage system.

In Example 12, the subject matter of Examples 9-15 (excluding the present Example) can optionally include:

receiving by a client node of the storage system for storage in the storage system, storage data including the first and second storage data,

erasure encoding the received data into chunks of erasure encoded chunks of the first and second storage data, at least some of which include parity data, and

transmitting to the third hierarchical switch, the consolidated multi-chunk placement request having a payload of erasure encoded chunks of the first and second storage data, for storage in the first and second sets of storage nodes, respectively.

In Example 13, the subject matter of Examples 9-15 (excluding the present Example) can optionally include:

in response to each data chunk placement request of the first set of data chunk placement requests, an assigned storage node of the first set of storage nodes storing an individual erasure encoded chunk of data of the first set of erasure encoded chunks of data, and sending to the first hierarchical switch a data chunk placement acknowledgment acknowledging storage of an individual erasure encoded chunk of data of the first set of erasure encoded chunks of data,

receiving by first hierarchical switch, a first plurality of data chunk placement acknowledgments, each data chunk placement acknowledgment acknowledging storage of an individual erasure encoded chunk of data of the first set of erasure encoded chunks of data in an assigned storage node of the first set of storage nodes, transmitting by the first hierarchical switch to the third switch in response to receipt of the first plurality of data chunk placement acknowledgments, a first multi-chunk data placement acknowledgement acknowledging storage of the first storage data in the first set of storage nodes of the storage system,

in response to each data chunk placement request of the second set of data chunk placement requests, an assigned storage node of the second set of storage nodes storing an individual erasure encoded chunk of data of the second set of erasure encoded chunks of data, and sending to the second hierarchical switch a data chunk placement acknowledgment acknowledging storage of an individual erasure encoded chunk of data of the second set of erasure encoded chunks of data,

receiving by second hierarchical switch, a second plurality of data chunk placement acknowledgments, each data chunk placement acknowledgment of the second set acknowledging storage of an individual erasure encoded chunk of data of the second set of erasure encoded chunks of data in an assigned storage node of the second set of storage nodes, and

transmitting by the second hierarchical switch to the third switch in response to receipt of the second plurality of data chunk placement acknowledgments, a second multi-chunk data placement acknowledgement acknowledging storage of the second storage data in the second set of storage nodes of the storage system.

In Example 14, the subject matter of Examples 9-15 (excluding the present Example) can optionally include receiving by third hierarchical switch, the first and second multi-chunk data placement acknowledgements and transmitting to a client node of the storage system, a consolidated multi-chunk placement acknowledgment acknowledging storage of the first and second storage data in the first and second sets, respectively, of storage nodes of the storage system.

In Example 15, the subject matter of Examples 9-15 (excluding the present Example) can optionally include erasure encoding by the first hierarchical switch, the first storage data of the first distributed multi-chunk data placement request received by the first hierarchical switch, to the erasure encoded chunks of data for the first set of data chunk placement requests to place the individual erasure encoded chunks of data of the first storage data, in assigned storage nodes of the first set of storage nodes.

Example 16 is an apparatus comprising means to perform a method as claimed in any preceding Example.

Example 17 is a storage system, comprising:

a hierarchical communication network having a plurality of storage nodes configured to store data, the network comprising:

a first hierarchical switch at a first hierarchical level in the hierarchical communication network of the storage system, the first hierarchical switch having intra-rack request generation logic configured to detect receipt of a first distributed multi-chunk data placement request to place first storage data in a first set of storage nodes of the storage system, and in response to the first distributed multi-chunk data placement request, generate and transmit a first set of data chunk placement requests to assigned storage nodes of the first set of storage nodes, wherein each data chunk placement request is a request to place an individual erasure encoded chunk of data of the first storage data, in an assigned storage node of the first set of storage nodes.

In Example 18, the subject matter of Examples 17-24 (excluding the present Example) can optionally include:

a second hierarchical switch at the first hierarchical level in the hierarchical communication network of the storage system, the second hierarchical switch having intra-rack request generation logic configured to detect receipt of a second distributed multi-chunk data placement request to place second storage data in a second set of storage nodes of the storage system, and in response to the second distributed multi-chunk data placement request, generate and transmit a second set of data chunk placement requests to assigned storage nodes of the second set of storage nodes, wherein each data chunk placement request of the second set is a request to place an individual erasure encoded chunk of data of the second storage data, in an assigned storage node of the second set of storage nodes.

In Example 19, the subject matter of Examples 17-24 (excluding the present Example) can optionally include wherein the first hierarchical level of the first and second hierarchical switches is at a lower hierarchical level as compared to a second hierarchical level of the hierarchical communication network of the storage system, the system further comprising:

a third hierarchical switch at the second hierarchical level, the third hierarchical switch having inter-rack request generation logic configured to detect a consolidated multi-chunk placement request to place storage data including the first and second storage data, in storage in a set of storage nodes of the storage system including the first and second sets of storage nodes, and in response to the consolidated multi-chunk placement request, generate and transmit the first distributed multi-chunk data placement request to the first hierarchical switch to place the first storage data in the first set of storage nodes of the storage system, and the second distributed multi-chunk data placement request to the second hierarchical switch to place the second storage data in the second set of storage nodes of the storage system.

In Example 20, the subject matter of Examples 17-24 (excluding the present Example) can optionally include:

a client node coupled to the third hierarchical switch, and having consolidated placement request logic configured to receive storage data including the first and second storage data, erasure encode the received data into chunks of erasure encoded chunks of the first and second storage data, at least some of which include parity data, and generate and transmit to the third hierarchical switch, the consolidated multi-chunk placement request having a payload of erasure encoded chunks of the first and second storage data, for storage in the first and second sets of storage nodes, respectively.

In Example 21, the subject matter of Examples 17-24 (excluding the present Example) can optionally include:

a first storage rack having the first set of storage nodes, each storage node of the first set having chunk placement logic configured to, in response to a data chunk placement request of the first set of data chunk placement requests, received by the assigned storage node of the first set of storage nodes, store an individual erasure encoded chunk of data of the first set of erasure encoded chunks of data, each storage node of the first set further having placement acknowledgement generation logic configured to send to the first hierarchical switch a data chunk placement acknowledgment acknowledging storage of an individual erasure encoded chunk of data of the first set of erasure encoded chunks of data,

wherein the first hierarchical switch has intra-rack acknowledgement consolidation logic configured to receive a first plurality of data chunk placement acknowledgments, each data chunk placement acknowledgment acknowledging storage of an individual erasure encoded chunk of data of the first set of erasure encoded chunks of data in an assigned storage node of the first set of storage nodes, and generate and transmit to the third switch in response to receipt of the first plurality of data chunk placement acknowledgments, a first multi-chunk data placement acknowledgement acknowledging storage of the first storage data in the first set of storage nodes of the storage system,

a second storage rack having the second set of storage nodes, each storage node of the second set having chunk placement logic configured to, in response to a data chunk placement request of the second set of data chunk placement requests, received by the assigned storage node of the second set of storage nodes, store an individual erasure encoded chunk of data of the second set of erasure encoded chunks of data, each storage node of the second set further having placement acknowledgement generation logic configured to send to the second hierarchical switch a data chunk placement acknowledgment acknowledging storage of an individual erasure encoded chunk of data of the second set of erasure encoded chunks of data,

wherein the second hierarchical switch has intra-rack acknowledgement consolidation logic configured to receive a second plurality of data chunk placement acknowledgments, each data chunk placement acknowledgment acknowledging storage of an individual erasure encoded chunk of data of the second set of erasure encoded chunks of data in an assigned storage node of the second set of storage nodes, and generate and transmit to the third switch in response to receipt of the second plurality of data chunk placement acknowledgments, a second multi-chunk data placement acknowledgement acknowledging storage of the second storage data in the second set of storage nodes of the storage system.

In Example 22, the subject matter of Examples 17-24 (excluding the present Example) can optionally include wherein the third hierarchical switch has inter-rack acknowledgment consolidation logic configured to receive the first and second multi-chunk data placement acknowledgements and generate and transmit to the client node of the storage system, a consolidated multi-chunk placement acknowledgment acknowledging storage of the first and second storage data in the first and second sets, respectively, of storage nodes of the storage system.

In Example 23, the subject matter of Examples 17-24 (excluding the present Example) can optionally include wherein the intra-rack request generation logic is further configured to erasure encode the first storage data of the first distributed multi-chunk data placement request received by the first hierarchical switch, to the erasure encoded chunks of data for the first set of data chunk placement requests to place the individual erasure encoded chunks of data of the first storage data, in assigned storage nodes of the first set of storage nodes.

In Example 24, the subject matter of Examples 17-24 (excluding the present Example) can optionally include a display communicatively coupled to the switch.

Example 25 is an apparatus for use with a hierarchical communication network of a storage system having a plurality of storage nodes configured to store data, comprising:

a first hierarchical switch at a first hierarchical level in the hierarchical communication network of the storage system, the first hierarchical switch having intra-rack request generation logic means configured for detecting receipt of a first distributed multi-chunk data placement request to place first storage data in a first set of storage nodes of the storage system, and in response to the first distributed multi-chunk data placement request, generating and transmitting a first set of data chunk placement requests to assigned storage nodes of the first set of storage nodes, wherein each data chunk placement request is a request to place an individual erasure encoded chunk of data of the first storage data, in an assigned storage node of the first set of storage nodes.

In Example 26, the subject matter of Examples 25-31 (excluding the present Example) can optionally include:

a second hierarchical switch at the first hierarchical level in the hierarchical communication network of the storage system, the second hierarchical switch having intra-rack request generation logic means configured for detecting receipt of a second distributed multi-chunk data placement request to place second storage data in a second set of storage nodes of the storage system, and in response to the second distributed multi-chunk data placement request, generating and transmitting a second set of data chunk placement requests to assigned storage nodes of the second set of storage nodes, wherein each data chunk placement request of the second set is a request to place an individual erasure encoded chunk of data of the second storage data, in an assigned storage node of the second set of storage nodes.

In Example 27, the subject matter of Examples 25-31 (excluding the present Example) can optionally include wherein the first hierarchical level of the first and second hierarchical switches is at a lower hierarchical level as compared to a second hierarchical level of the hierarchical communication network of the storage system, the apparatus further comprising:

a third hierarchical switch at the second hierarchical level, the third hierarchical switch having inter-rack request generation logic means configured for detecting a consolidated multi-chunk placement request to place storage data including the first and second storage data, in storage in a set of storage nodes of the storage system including the first and second sets of storage nodes, and in response to the consolidated multi-chunk placement request, generating and transmitting the first distributed multi-chunk data placement request to the first hierarchical switch to place the first storage data in the first set of storage nodes of the storage system, and the second distributed multi-chunk data placement request to the second hierarchical switch to place the second storage data in the second set of storage nodes of the storage system.

In Example 28, the subject matter of Examples 25-31 (excluding the present Example) can optionally include:

a client node coupled to the third hierarchical switch, and having consolidated placement request logic means configured for receiving storage data including the first and second storage data, erasure encoding the received data into chunks of erasure encoded chunks of the first and second storage data, at least some of which include parity data, and generating and transmitting to the third hierarchical switch, the consolidated multi-chunk placement request having a payload of erasure encoded chunks of the first and second storage data, for storage in the first and second sets of storage nodes, respectively.

In Example 29, the subject matter of Examples 25-31 (excluding the present Example) can optionally include:

a first storage rack having the first set of storage nodes, each storage node of the first set having chunk placement logic means configured for, in response to a data chunk placement request of the first set of data chunk placement requests, received by the assigned storage node of the first set of storage nodes, storing an individual erasure encoded chunk of data of the first set of erasure encoded chunks of data, each storage node of the first set further having placement acknowledgement generation logic means configured for sending to the first hierarchical switch a data chunk placement acknowledgment acknowledging storage of an individual erasure encoded chunk of data of the first set of erasure encoded chunks of data,

wherein the first hierarchical switch has intra-rack acknowledgement consolidation logic means configured for receiving a first plurality of data chunk placement acknowledgments, each data chunk placement acknowledgment acknowledging storage of an individual erasure encoded chunk of data of the first set of erasure encoded chunks of data in an assigned storage node of the first set of storage nodes, and generating and transmitting to the third switch in response to receipt of the first plurality of data chunk placement acknowledgments, a first multi-chunk data placement acknowledgement acknowledging storage of the first storage data in the first set of storage nodes of the storage system,

a second storage rack having the second set of storage nodes, each storage node of the second set having chunk placement logic means configured for, in response to a data chunk placement request of the second set of data chunk placement requests, received by the assigned storage node of the second set of storage nodes, storing an individual erasure encoded chunk of data of the second set of erasure encoded chunks of data, each storage node of the second set further having placement acknowledgement generation logic means configured for sending to the second hierarchical switch a data chunk placement acknowledgment acknowledging storage of an individual erasure encoded chunk of data of the second set of erasure encoded chunks of data,

wherein the second hierarchical switch has intra-rack acknowledgement consolidation logic means configured for receiving a second plurality of data chunk placement acknowledgments, each data chunk placement acknowledgment acknowledging storage of an individual erasure encoded chunk of data of the second set of erasure encoded chunks of data in an assigned storage node of the second set of storage nodes, and generating and transmitting to the third switch in response to receipt of the second plurality of data chunk placement acknowledgments, a second multi-chunk data placement acknowledgement acknowledging storage of the second storage data in the second set of storage nodes of the storage system.

In Example 30, the subject matter of Examples 25-31 (excluding the present Example) can optionally include wherein the third hierarchical switch has inter-rack acknowledgment consolidation logic means configured for receiving the first and second multi-chunk data placement acknowledgements and generating and transmitting to the client node of the storage system, a consolidated multi-chunk placement acknowledgment acknowledging storage of the first and second storage data in the first and second sets, respectively, of storage nodes of the storage system.

In Example 31, the subject matter of Examples 25-31 (excluding the present Example) can optionally include wherein the intra-rack request generation logic means is further configured for erasure encoding the first storage data of the first distributed multi-chunk data placement request received by the first hierarchical switch, to the erasure encoded chunks of data for the first set of data chunk placement requests to place the individual erasure encoded chunks of data of the first storage data, in assigned storage nodes of the first set of storage nodes.

Example 32 is a machine-readable storage including machine-readable instructions, when executed, to implement a method or realize an apparatus as claimed in preceding Examples 1-31.

The described operations may be implemented as a method, apparatus or computer program product using standard programming and/or engineering techniques to produce software, firmware, hardware, or any combination thereof. The described operations may be implemented as computer program code maintained in a “computer readable storage medium”, where a processor may read and execute the code from the computer storage readable medium. The computer readable storage medium includes at least one of electronic circuitry, storage materials, inorganic materials, organic materials, biological materials, a casing, a housing, a coating, and hardware. A computer readable storage medium may comprise, but is not limited to, a magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), Solid State Devices (SSD), etc. The code implementing the described operations may further be implemented in hardware logic implemented in a hardware device (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The program code embedded on a computer readable storage medium may be transmitted as transmission signals from a transmitting station or computer to a receiving station or computer. A computer readable storage medium is not comprised solely of transmissions signals. Those skilled in the art will recognize that many modifications may be made to this configuration without departing from the scope of the present description, and that the article of manufacture may comprise suitable information bearing medium known in the art. Of course, those skilled in the art will recognize that many modifications may be made to this configuration without departing from the scope of the present description, and that the article of manufacture may comprise any tangible information bearing medium known in the art.

In certain applications, a device in accordance with the present description, may be embodied in a computer system including a video controller to render information to display on a monitor or other display coupled to the computer system, a device driver and a network controller, such as a computer system comprising a desktop, workstation, server, mainframe, laptop, handheld computer, etc. Alternatively, the device embodiments may be embodied in a computing device that does not include, for example, a video controller, such as a switch, router, etc., or does not include a network controller, for example.

The illustrated logic of figures may show certain events occurring in a certain order. In alternative embodiments, certain operations may be performed in a different order, modified or removed. Moreover, operations may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to limit to the precise form disclosed. Many modifications and variations are possible in light of the above teaching.

What is claimed is:

1. An apparatus for use with a hierarchical communication network of a storage system having a plurality of storage nodes configured to store data, comprising:
a first hierarchical switch at a first hierarchical level in the hierarchical communication network of the storage system, the first hierarchical switch having intra-rack request generation logic configured to detect receipt of a first distributed multi-chunk data placement request to place first storage data in a first set of storage nodes of the storage system, and in response to the first distributed multi-chunk data placement request, generate and transmit a first set of data chunk placement requests to assigned storage nodes of the first set of storage nodes, wherein each data chunk placement request is a request to place an individual erasure encoded chunk of data of the first storage data, in an assigned storage node of the first set of storage nodes.

2. The apparatus of claim 1 further comprising:
a second hierarchical switch at the first hierarchical level in the hierarchical communication network of the storage system, the second hierarchical switch having intra-rack request generation logic configured to detect receipt of a second distributed multi-chunk data placement request to place second storage data in a second set of storage nodes of the storage system, and in response to the second distributed multi-chunk data placement request, generate and transmit a second set of data chunk placement requests to assigned storage nodes of the second set of storage nodes, wherein each data chunk placement request of the second set is a request to place an individual erasure encoded chunk of data of the second storage data, in an assigned storage node of the second set of storage nodes.

3. The apparatus of claim 2 wherein the first hierarchical level of the first and second hierarchical switches is at a lower hierarchical level as compared to a second hierarchical level of the hierarchical communication network of the storage system, the apparatus further comprising:
a third hierarchical switch at the second hierarchical level, the third hierarchical switch having inter-rack request generation logic configured to detect a consolidated multi-chunk placement request to place storage data including the first and second storage data, in storage in a set of storage nodes of the storage system including the first and second sets of storage nodes, and in response to the consolidated multi-chunk placement request, generate and transmit the first distributed multi-chunk data placement request to the first hierarchical switch to place the first storage data in the first set of storage nodes of the storage system, and the second distributed multi-chunk data placement request to the second hierarchical switch to place the second storage data in the second set of storage nodes of the storage system.

4. The apparatus of claim 3 further comprising:
a client node coupled to the third hierarchical switch, and having consolidated placement request logic configured to receive storage data including the first and second storage data, erasure encode the received data into chunks of erasure encoded chunks of the first and second storage data, at least some of which include parity data, and generate and transmit to the third hierarchical switch, the consolidated multi-chunk placement request having a payload of erasure encoded chunks of the first and second storage data, for storage in the first and second sets of storage nodes, respectively.

5. The apparatus of claim 4 further comprising:
a first storage rack having the first set of storage nodes, each storage node of the first set having chunk placement logic configured to, in response to a data chunk placement request of the first set of data chunk placement requests, received by the assigned storage node of the first set of storage nodes, store an individual erasure encoded chunk of data of the first set of erasure encoded chunks of data, each storage node of the first set further having placement acknowledgement generation logic configured to send to the first hierarchical switch a data chunk placement acknowledgment acknowledging storage of an individual erasure encoded chunk of data of the first set of erasure encoded chunks of data;
wherein the first hierarchical switch has intra-rack acknowledgement consolidation logic configured to receive a first plurality of data chunk placement acknowledgments, each data chunk placement acknowledgment acknowledging storage of an individual erasure encoded chunk of data of the first set of erasure encoded chunks of data in an assigned storage node of the first set of storage nodes, and generate and transmit to the third switch in response to receipt of the first plurality of data chunk placement acknowledgments, a first multi-chunk data placement acknowledgement acknowledging storage of the first storage data in the first set of storage nodes of the storage system;
a second storage rack having the second set of storage nodes, each storage node of the second set having chunk placement logic configured to, in response to a data chunk placement request of the second set of data chunk placement requests, received by the assigned storage node of the second set of storage nodes, store an individual erasure encoded chunk of data of the second set of erasure encoded chunks of data, each storage node of the second set further having placement acknowledgement generation logic configured to send to the second hierarchical switch a data chunk placement acknowledgment acknowledging storage of an individual erasure encoded chunk of data of the second set of erasure encoded chunks of data;
wherein the second hierarchical switch has intra-rack acknowledgement consolidation logic configured to receive a second plurality of data chunk placement acknowledgments, each data chunk placement acknowledgment acknowledging storage of an individual erasure encoded chunk of data of the second set of erasure encoded chunks of data in an assigned storage node of the second set of storage nodes, and generate and transmit to the third switch in response to receipt of the second plurality of data chunk placement acknowledgments, a second multi-chunk data placement acknowledgement acknowledging storage of the second storage data in the second set of storage nodes of the storage system.

6. The apparatus of claim 5 wherein the third hierarchical switch has inter-rack acknowledgment consolidation logic configured to receive the first and second multi-chunk data placement acknowledgements and generate and transmit to the client node of the storage system, a consolidated multi-chunk placement acknowledgment acknowledging storage of the first and second storage data in the first and second sets, respectively, of storage nodes of the storage system.

7. The apparatus of claim 1 wherein the intra-rack request generation logic is further configured to erasure encode the first storage data of the first distributed multi-chunk data placement request received by the first hierarchical switch, to the erasure encoded chunks of data for the first set of data chunk placement requests to place the individual erasure encoded chunks of data of the first storage data, in assigned storage nodes of the first set of storage nodes.

8. A method, comprising:
detecting by a first hierarchical switch at a first hierarchical level in a hierarchical communication network of a storage system, a first distributed multi-chunk data placement request to place first storage data in a first set of storage nodes of the storage system ; and
in response to the first distributed multi-chunk data placement request, transmitting by the first hierarchical switch, a first set of data chunk placement requests to assigned storage nodes of the first set of storage nodes, wherein each data chunk placement request is a request to place an individual erasure encoded chunk of data of the first storage data, in an assigned storage node of the first set of storage nodes.

9. The method of claim 8 further comprising:
detecting by a second hierarchical switch at the first hierarchical level in a hierarchical communication network of a storage system, a second distributed multi-chunk data placement request to place second storage data in a second set of storage nodes of the storage system ; and
in response to the second distributed multi-chunk data placement request, transmitting by the second hierarchical switch, a second set of data chunk placement requests to assigned storage nodes of the second set of storage nodes, wherein each data chunk placement request of the second set of data chunk placement requests is a request to place an individual erasure encoded chunk of data of the second storage data, in an assigned storage node of the second set of storage nodes.

10. The method of claim 9 wherein the first hierarchical level of the first and second hierarchical switches is at a lower hierarchical level as compared to a second hierarchical level of a third hierarchical switch in the hierarchical communication network of the storage system, the method further comprising:
detecting by the third hierarchical switch, a consolidated multi-chunk placement request to place storage data including the first and second storage data, in storage in a set of storage nodes of the storage system including the first and second sets of storage nodes;
in response to the consolidated multi-chunk placement request, transmitting by the third hierarchical switch, the first distributed multi-chunk data placement request to the first hierarchical switch to place the first storage data in the first set of storage nodes of the storage system; and
in response to the third transmission of data, transmitting by the third hierarchical switch, the second distributed multi-chunk data placement request to the second hierarchical switch to place the second storage data in the second set of storage nodes of the storage system.

11. The method of claim 10 further comprising:
receiving by a client node of the storage system for storage in the storage system, storage data including the first and second storage data;
erasure encoding the received data into chunks of erasure encoded chunks of the first and second storage data, at least some of which include parity data; and
transmitting to the third hierarchical switch, the consolidated multi-chunk placement request having a payload of erasure encoded chunks of the first and second storage data, for storage in the first and second sets of storage nodes, respectively.

12. The method of claim 10 further comprising:
in response to each data chunk placement request of the first set of data chunk placement requests, an assigned storage node of the first set of storage nodes storing an individual erasure encoded chunk of data of the first set of erasure encoded chunks of data, and sending to the first hierarchical switch a data chunk placement acknowledgment acknowledging storage of an individual erasure encoded chunk of data of the first set of erasure encoded chunks of data;
receiving by first hierarchical switch, a first plurality of data chunk placement acknowledgments, each data chunk placement acknowledgment acknowledging storage of an individual erasure encoded chunk of data of the first set of erasure encoded chunks of data in an assigned storage node of the first set of storage nodes;
transmitting by the first hierarchical switch to the third switch in response to receipt of the first plurality of data chunk placement acknowledgments, a first multi-chunk data placement acknowledgement acknowledging storage of the first storage data in the first set of storage nodes of the storage system;
in response to each data chunk placement request of the second set of data chunk placement requests, an assigned storage node of the second set of storage nodes storing an individual erasure encoded chunk of data of the second set of erasure encoded chunks of data, and sending to the second hierarchical switch a data chunk placement acknowledgment acknowledging storage of an individual erasure encoded chunk of data of the second set of erasure encoded chunks of data;
receiving by second hierarchical switch, a second plurality of data chunk placement acknowledgments, each data chunk placement acknowledgment of the second set acknowledging storage of an individual erasure encoded chunk of data of the second set of erasure encoded chunks of data in an assigned storage node of the second set of storage nodes; and
transmitting by the second hierarchical switch to the third switch in response to receipt of the second plurality of data chunk placement acknowledgments, a second multi-chunk data placement acknowledgement acknowledging storage of the second storage data in the second set of storage nodes of the storage system.

13. The method of claim 12 further comprising receiving by third hierarchical switch, the first and second multi-chunk data placement acknowledgements and transmitting to a client node of the storage system, a consolidated multi-chunk placement acknowledgment acknowledging storage of the first and second storage data in the first and second sets, respectively, of storage nodes of the storage system.

14. The method of claim 8 further comprising erasure encoding by the first hierarchical switch, the first storage data of the first distributed multi-chunk data placement request received by the first hierarchical switch, to the erasure encoded chunks of data for the first set of data chunk placement requests to place the individual erasure encoded chunks of data of the first storage data, in assigned storage nodes of the first set of storage nodes.

15. A storage system, comprising:
a hierarchical communication network having a plurality of storage nodes configured to store data, the network comprising:
a first hierarchical switch at a first hierarchical level in the hierarchical communication network of the storage system, the first hierarchical switch having intra-rack request generation logic configured to detect receipt of a first distributed multi-chunk data placement request to place first storage data in a first set of storage nodes of the storage system, and in response to the first distributed multi-chunk data placement request, generate and transmit a first set of data chunk placement requests to assigned storage nodes of the first set of storage nodes, wherein each data chunk placement request is a request to place an individual erasure encoded chunk of data of the first storage data, in an assigned storage node of the first set of storage nodes.

16. The system of claim 15 further comprising:
a second hierarchical switch at the first hierarchical level in the hierarchical communication network of the storage system, the second hierarchical switch having intra-rack request generation logic configured to detect receipt of a second distributed multi-chunk data placement request to place second storage data in a second set of storage nodes of the storage system, and in response to the second distributed multi-chunk data placement request, generate and transmit a second set of data chunk placement requests to assigned storage nodes of the second set of storage nodes, wherein each data chunk placement request of the second set is a request to place an individual erasure encoded chunk of data of the second storage data, in an assigned storage node of the second set of storage nodes.

17. The system of claim 16 wherein the first hierarchical level of the first and second hierarchical switches is at a lower hierarchical level as compared to a second hierarchical level of the hierarchical communication network of the storage system, the system further comprising:
a third hierarchical switch at the second hierarchical level, the third hierarchical switch having inter-rack request generation logic configured to detect a consolidated multi-chunk placement request to place storage data including the first and second storage data, in storage in a set of storage nodes of the storage system including the first and second sets of storage nodes, and in response to the consolidated multi-chunk placement request, generate and transmit the first distributed multi-chunk data placement request to the first hierarchical switch to place the first storage data in the first set of storage nodes of the storage system, and the second distributed multi-chunk data placement request to the second hierarchical switch to place the second storage data in the second set of storage nodes of the storage system.

18. The system of claim 17 further comprising:
a client node coupled to the third hierarchical switch, and having consolidated placement request logic configured to receive storage data including the first and second storage data, erasure encode the received data into chunks of erasure encoded chunks of the first and second storage data, at least some of which include parity data, and generate and transmit to the third hierarchical switch, the consolidated multi-chunk placement request having a payload of erasure encoded chunks of the first and second storage data, for storage in the first and second sets of storage nodes, respectively.

19. The system of claim 18 further comprising:
a first storage rack having the first set of storage nodes, each storage node of the first set having chunk placement logic configured to, in response to a data chunk placement request of the first set of data chunk placement requests, received by the assigned storage node of the first set of storage nodes, store an individual erasure encoded chunk of data of the first set of erasure encoded chunks of data, each storage node of the first set further having placement acknowledgement generation logic configured to send to the first hierarchical switch a data chunk placement acknowledgment acknowledging storage of an individual erasure encoded chunk of data of the first set of erasure encoded chunks of data;
wherein the first hierarchical switch has intra-rack acknowledgement consolidation logic configured to receive a first plurality of data chunk placement acknowledgments, each data chunk placement acknowledgment acknowledging storage of an individual erasure encoded chunk of data of the first set of erasure encoded chunks of data in an assigned storage node of the first set of storage nodes, and generate and transmit to the third switch in response to receipt of the first plurality of data chunk placement acknowledgments, a first multi-chunk data placement acknowledgement acknowledging storage of the first storage data in the first set of storage nodes of the storage system;
a second storage rack having the second set of storage nodes, each storage node of the second set having chunk placement logic configured to, in response to a data chunk placement request of the second set of data chunk placement requests, received by the assigned storage node of the second set of storage nodes, store an individual erasure encoded chunk of data of the second set of erasure encoded chunks of data, each storage node of the second set further having placement acknowledgement generation logic configured to send to the second hierarchical switch a data chunk placement acknowledgment acknowledging storage of an individual erasure encoded chunk of data of the second set of erasure encoded chunks of data;
wherein the second hierarchical switch has intra-rack acknowledgement consolidation logic configured to receive a second plurality of data chunk placement acknowledgments, each data chunk placement acknowledgment acknowledging storage of an individual erasure encoded chunk of data of the second set of erasure encoded chunks of data in an assigned storage node of the second set of storage nodes, and generate and transmit to the third switch in response to receipt of the second plurality of data chunk placement acknowledgments, a second multi-chunk data placement acknowledgement acknowledging storage of the second storage data in the second set of storage nodes of the storage system.

20. The system of claim 19 wherein the third hierarchical switch has inter-rack acknowledgment consolidation logic configured to receive the first and second multi-chunk data placement acknowledgements and generate and transmit to the client node of the storage system, a consolidated multi-chunk placement acknowledgment acknowledging storage of the first and second storage data in the first and second sets, respectively, of storage nodes of the storage system.

21. The system of claim 15 wherein the intra-rack request generation logic is further configured to erasure encode the first storage data of the first distributed multi-chunk data placement request received by the first hierarchical switch, to the erasure encoded chunks of data for the first set of data chunk placement requests to place the individual erasure encoded chunks of data of the first storage data, in assigned storage nodes of the first set of storage nodes.

22. The system of claim 15 further comprising a display communicatively coupled to the switch.
